(19) United States
(12) Patent Application Publication
(10) Pub. No.: US 2020/0217979 A1
(43) Pub. Date: Jul. 9, 2020

(54) OBSERVATION-DRIVEN METHOD BASED ON IIR WIENER FILTER FOR MICROSEISMIC DATA DENOISING

(71) Applicant: King Fahd University of Petroleum and Minerals, Dhahran (SA)

(72) Inventors: Naveed IQBAL, Dhahran (SA); Azzedine Mohamed Ali Zerguine, Dhahran (SA); Abdullatif Abdulrahman Al-Shuhail, Dhahran (SA); Sanlinn Isma'il Ebrahim Kaka, Dhahran (SA)

(73) Assignee: King Fahd University of Petroleum and Minerals, Dhahran (SA)

(21) Appl. No.: 16/242,705

(22) Filed: Jan. 8, 2019

(51) Int. Cl. G01V 1/36; G01V 1/28

(52) U.S. Cl. CPC G01V 1/366; G01V 1/288

(57) ABSTRACT

A system and method and non-transitory computer readable medium method for filtering signals representative of microseismic events with an infinite impulse response (IIR) Wiener filter which precludes the need for statistics or prior knowledge of the signal of interest. The second-order statistics of the noise and the noisy data are extracted from the recorded data only. The criteria used to optimize the filter impulse response is the minimization of the mean square error. The IIR Wiener filter was tested on synthetic and field data sets and found to be effective in denoising microseismic data with low SNR (−2 dB).

### BACKGROUND OF THE INVENTION

### Field of the Invention

The present disclosure is directed to denoising microseismic data with an infinite impulse response (IIR) Wiener filter. A mean square error (MSE) cost function of the observed signals and the second order statistics of the noise is used as a basis to derive the filter coefficients without prior knowledge of the signal or noise statistics.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

A microseismic event is considered to be a small magnitude earthquake, having a magnitude as low as −3. (See Maxwell, S. C., Shemeta, J. E., Campbell, E., & Quirk, D. J. (2008). “Microseismic deformation rate monitoring”. In SPE Annual Technical Conference and Exhibition. Society of Petroleum Engineers, incorporated herein by reference in its entirety). It can occur as a natural phenomenon or as a result of human activities within the earth. Analysis of artificially induced microseismic events is essential for oil and gas reservoir geophysics, and for geological carbon dioxide storage. (See Kendall, M., Maxwell, S., Foulger, G., Eisner, L., & Lawrence, Z. (2011). “Microseismicity: Beyond dots in a box Introduction”. Geophysics, 76(6), WC1-WC3; and Verdon, J. (2011). Microseismic monitoring and geo-mechanical modeling of storage in subsurface reservoirs”. Geophysics, 76(5), Z102-Z103, each incorporated herein by reference in their entirety. Both of these examples of applications of microseismic monitoring are related to conventional reservoirs.

However, microseismic analysis is used extensively in unconventional reservoirs as well for imaging the fracture networks. Moreover, microseismic monitoring has been common in the mining industry for over 100 years where it is primarily used for safety from rockbursts and assessing the state of stress within a mine, in the study of water reservoir-induced seismicity and in the geothermal industry, but its application in the oil and gas industry is relatively new. (See Castellanos, F., & Van der Baan, M. (2013). “Microseismic event locations using the double-difference algorithm”. CSEG Recorder, 38, 26-37; Mendecki, A. (1993). “Real time quantitative seismology in mines”. In 3rd International Symposium on Rockbursts and Seismicity in Mines (pp. 287-295). Canada: Kingston; Simpson, D., Leith, W., & Scholz, C. (1988). “Two types of reservoir-induced seismicity”. Bulletin of the Seismological Society of America, 78(6), 2025-2040; and Pearson, C. (1981) “The relationship between microseismicity and high pore pressures during hydraulic stimulation experiments in low permeability granitic rocks”. Journal of Geophysical Research: Solid Earth, 86(B9), 7855-7864, each incorporated herein by reference in their entirety).

During fracking high-pressure fluid is typically injected to fracture rock and increase permeability, thus enhancing production. During such a process, microfractures can be induced in the vicinity of the injection well. Monitoring and analyzing these microfractures helps to understand the rock-breaking mechanisms during the injection process and during reservoir exploitation. (See Maxwell, S. C. (2011). “What does microseismicity tells us about hydraulic fractures?” In SEG Technical Program Expanded Abstracts 2011, pp. 1565-1569. Society of Exploration Geophysicists, incorporated herein by reference in its entirety). In order to locate the microseismic hypocenters, the accurate identification of microseismic events is crucial.

To monitor microseismic events, typically 8 to 12 three-component sensors are placed in a nearby wells or on the earth's surface. (See Caffagni, E., Eaton, D. W., Jones, J. P., & van der Baan, M. (2016). “Detection and analysis of microseismic events using a Matched Filtering Algorithm (MFA)”. Geophysical Journal International, 206(1), 644-658; and Eaton, D. W., Van der Baan, M., Birkelo, B., & Tary, J.-B. (2014). “Scaling relations and spectral characteristics of tensile microseisms: Evidence for opening/closing cracks during hydraulic fracturing”. Geophysical Journal International, 196(3), 1844-1857, each incorporated herein by reference in their entirety). Since it is more cost effective to place geophones on the surface than burying them deeply in a borehole, several hundred sensors can be used in surface arrays. (See Duncan, P. M. (2012). “Microseismic monitoring for unconventional resource development”. Geohorizons, 26-30, incorporated herein by reference in its entirety).

Surface arrays offer other advantages as well. For example, it is known that the accuracy and precision of the hypocenter locations in microseismic monitoring depend on both the Signal-to-Noise Ratio (SNR) of the recorded data and the spatial distribution of the receivers. Usually, downhole monitoring provides better detection due to a higher SNR; however, the precise location of events might be difficult, especially in the case of a single monitoring well. (See Eisner, L., Hulsey, B. J., Duncan, P., Jurick, D., Werner, H., & Keller, W. (2010). “Comparison of surface and borehole locations of induced seismicity”. Geophysical Prospecting, 58(5), 809-820, incorporated herein by reference in its entirety). Depth estimation of epicentral errors for microseismic event locations using downhole arrays increases as a function of distance from the monitoring well. Although surface monitoring often suffers from low SNR, the ability to place receivers at multiple azimuths and offsets allows for precise epicenter (horizontal) event location. (See Mousavi et al. “Fast and novel microseismic detection using time-frequency analysis”, SEG Technical Program Expanded Abstracts 2016, pages 2632-2636, Society of Exploration Geophysicists, incorporated herein by reference in its entirety).

Surface microseismic data are characterized by low SNR and consequently, the main challenge in the study of microseismic events is to enhance the SNR by suppressing/removing the noise. (See Shemeta, J., & Anderson, P. (2010). “It's a matter of size: Magnitude and moment estimates for microseismic data”. The Leading Edge, 29(3), 296-302, incorporated herein by reference in its entirety).

Several denoising or signal-to-noise ratio (SNR) enhancement methods exist in the literature. Seismic interferometry is a well-known technique to enhance the SNR of the seismic data record, which includes cross-correlation, stacking, and convolution. (See Al-shuhail, A., Aldawood, A., and Hanafy, S. (2012). “Application of super-virtual seismic refraction interferometry to enhance first arrivals: A case study from Saudi Arabia”. The Leading Edge, 31:34-39; Bharadwaj, P., Wang, X., Schuster, G., and McIntosh, K. (2013). “Increasing the number and signal-to-noise ratio of OBS traces with supervirtual refraction interferometry and free-surface multiples”. Geophysical Journal International, 192(3):1070-1084; and Mallinson, I., Bharadwaj, P., Schuster, G., and Jakubowicz, H. (2011). “Enhanced refractor imaging by supervirtual interferometry”. The Leading Edge, 30(5):546-560, each incorporated herein by reference in their entirety). A different approach that allows the reconstruction of signals from noisy observations is based on time-frequency analysis. (See Mousavi, S. M. and Langston, C. “Fast and novel microseismic detection using time-frequency analysis”. In SEG Technical Program Expanded Abstracts 2016, pages 2632-2636. Society of Exploration Geophysicists; Mousavi, S. M. and Langston, C. A. “Adaptive noise estimation and suppression for improving microseismic event detection”. Journal of Applied Geophysics, 132:116-124; and Vera Rodriguez, I., Bonar, D., and Sacchi, M. (2012). “Microseismic data denoising using a 3C group sparsity constrained time-frequency transform”. Geophysics, 77:V21-V29, each incorporated herein by reference in their entirety). These filtering methods encode the noisy signal as the instantaneous frequency of a frequency modulated analytic signal. The signal is recovered by estimating the peak of the time-frequency distribution of the analytic signal. This approach is sensitive to the noise interferences which detract the energy concentration in time-frequency distribution. Furthermore, a wavelet transform is used to decompose the noisy signal into time-frequency components using the appropriate mother wavelet. A threshold is necessary to obtain the enhanced signal. Proper selection of the mother wavelet and the number of decomposition levels are crucial for these methods.

A reassignment strategy, together with pre-processing and post-processing steps, are added in time-frequency based method for improving the denoising results. See Mousavi, S. M. and Langston, C. A. “Automatic noise-removal/signal-removal based on general cross-validation thresholding in synchrosqueezed domain and its application on earthquake data”. GEOPHYSICS, 82(4):V211-V227, incorporated herein by reference in its entirety).

A data driven approach that derives the basis function from the noisy signal is known as empirical mode decomposition. (See Han, J. and van der Baan, M. (2015). “Microseismic and seismic denoising via ensemble empirical mode decomposition and adaptive thresholding”. GEOPHYSICS, 80(6):KS69-KS80, incorporated herein by reference in its entirety). However, for this decomposition, the basis function suffers from inaccuracy due to the large noise component in the denoising results in a low SNR environment.

Other denoising methods that are based on thresholding in time-frequency transforms, e.g. the Radon transform, reduced-rank filtering and damped multichannel singular spectrum analysis are known. (See Sabbione, J. I., Sacchi, M. D., and Velis, D. R. (2015). “Radon transform-based microseismic event detection and signal-to-noise ratio enhancement”. Journal of Applied Geophysics, 113:51-63; Sabbione, J. I. and Velis, D. R. (2013). “A robust method for microseismic event detection based on automatic phase pickers”. Journal of Applied Geophysics, 99:42-50; Iqbal, N., Zerguine, A., Kaka, S., and Al-Shuhail, A. (2016). “Automated SVD filtering of time-frequency distribution for enhancing the SNR of microseismic/microquake events”. Journal of Geophysics and Engineering, 13(6):964-973; Sabbione, J. I., Velis, D. R., and Sacchi, M. D. (2013). “Microseismic data denoising via an apex-shifted hyperbolic Radon transform”. In SEG Technical Program Expanded Abstracts 2013, pages 2155-2161. Society of Exploration Geophysicists; and Huang, W., Wang, R., Chen, Y., Li, H., and Gan, S. (2016). “Damped multichannel singular spectrum analysis for 3D random noise attenuation”. GEOPHYSICS, 81(4):V261-V270, each incorporated herein by reference in their entirety).

Denoising using a Wiener filter approach is also a method in seismic surveying. (See Haldorsen, J. B. U., Miller, D. E., and Walsh, J. J. (1994). “Multichannel Wiener deconvolution of vertical seismic profiles”. GEOPHYSICS, 59(10):1500-1511; and Peacock, K. L. and Treitel, S. (1969). “Predictive deconvolution: Theory and practice”. GEOPHYSICS, 34(2):155-169, each incorporated herein by reference in their entirety). However, the Wiener filter method requires knowledge of the statistics of the signal, which is not normally available in practice.

A solution to this difficulty is to use the wavelet transform to partially differentiate the signal from the noise in an initial stage and then to apply the Wiener filter after calculating the signal statistics. (See Aghayan, A., Jaiswal, P., & Siahkoohi, H. R. (2016). “Seismic denoising using the redundant lifting scheme”. Geophysics, 81(3), V249-V260; and Kimiaefar, R., Siahkoohi, H. R., Hajian, A. R., & Kalhor, A. (2016). “Seismic random noise attenuation using artificial neural network and wavelet packet analysis”. Arabian Journal of Geosciences, 9(3), 234, each incorporated herein by reference in their entirety). In these methods, wavelets are used to extract the high and low frequency components. The high frequency components are assumed to be noise. A threshold and a basis function (mother wavelet) is needed for this purpose. Proper selection of the mother wavelet is crucial in wavelet transform and denoising results are greatly affected by the type of wavelet.

Improving the SNR of speech signals using the Wiener filter without knowing the signal statistics was proposed by Chen et al., who calculated noise statistics using the silence intervals in speech that represent pure noise (including electronically produced noise). (See Chen, J., Benesty, J., Yiteng Huang, and Doclo, S. (2006). “New insights into the noise reduction Wiener filter”. IEEE Transactions on Audio, Speech and Language Processing, 14(4):1218-1234, incorporated herein by reference in its entirety).

Similar approaches are also used in seismology by intuitively finding the noise-only part in data prior to earthquake or controlled source occurrence. (See Baziw, E. and Weir-Jones, I. (2002). “Application of Kalman Filtering Techniques for Microseismic Event Detection”. Pure and Applied Geophysics, 159(1):449-471; Coughlin, M., Harms, J., Christensen, N., Dergachev, V., DeSalvo, R., Kandhasamy, S., and Mandic, V. (2014). “Wiener filtering with a seismic underground array at the Sanford Underground Research Facility”. Classical and Quantum Gravity, 31(21):215003; Khadhraoui, B. and Ozbek, A. (2013). “Multicomponent Time-Frequency Noise Attenuation of Microseismic Data”. In 75th EAGE Conference and Exhibition incorporating SPE EUROPEC 2013, pages 200-204; Mousavi, S. M. and Langston, C. A. (2016). “Hybrid Seismic Denoising Using Higher Order Statistics and Improved Wavelet Block Thresholding”. Bulletin of the Seismological Society of America, 106(4):1380-1393; Wang, J., Tilmann, F., White, R. S., and Bordoni, P. (2009). “Application of frequency-dependent multichannel Wiener filters to detect events in 2D three-component seismometer arrays”. GEOPHYSICS, 74(6):V133-V141; and Wang, J., Tilmann, F., White, R. S., Soosalu, H., and Bordoni, P. (2008). “Application of multichannel Wiener filters to the suppression of ambient seismic noise in passive seismic arrays”. The Leading Edge, 27(2):232-238, each incorporated herein by reference in their entirety).

Intuitively finding the noise-only part in surface microseismic data is very difficult due to low SNR. Hence, the main challenge in microseismic surface monitoring is the realistic estimation of the seismic noise.

Mousavi and Langston proposed minimally controlled recursive averaging in the short-time Fourier transform domain for estimating noise. (See Mousavi, S. M. and Langston, C. A. (2016). “Adaptive noise estimation and suppression for improving microseismic event detection”. Journal of Applied Geophysics, 132:116-124, incorporated herein by reference in its entirety). The method of Mousavi and Langston was based on the work of Martin and Cohen. (See Martin, R. (2001). “Noise power spectral density estimation based on optimal smoothing and minimum statistics”. IEEE Transactions on Speech and Audio Processing, 9(5):504-512; and Cohen, I. (2003). “Noise spectrum estimation in adverse environments: improved minima controlled recursive averaging”. IEEE Transactions on Speech and Audio Processing, 11(5):466-475, each incorporated herein by reference in their entirety). However, this approach requires a large adaptation time (which yields incorrect locations of events) and the threshold is also fixed for all the frequencies. (See Rangachari, S. and Loizou, P. C. (2006). “A noise-estimation algorithm for highly non-stationary environments”. Speech Communication, 48(2):220-231, incorporated herein by reference in its entirety). The FIR Wiener filter with a noise estimation approach of Rangachari and Loizou differs from the IIR Wiener filter approach.

A Wiener filter is used to statistically estimate the desired signal from the noisy seismic trace, usually in the case of additive noise. Typically, filters are designed for a specific frequency response. However, the Wiener filter adopts a different approach. It is required to have prior statistical knowledge of the desired signal and the noise (or the observation) and the filter is designed so that its output signal matches with the original desired signal as much as possible. With proper design, a Wiener filter can be used to filter out the noise to get the underlying signal of interest. The present disclosure presents a method for designing an infinite impulse response (IIR) Wiener filter without prior statistical knowledge.

It is an object of the present disclosure to provide a method for denoising microseismic data with an infinite impulse response (IIR) Wiener filter. In one aspect, two features of the microseismic data are considered.

Features used for denoising microseismic data in the present disclosure are able to handle many conditions. First, the occurrence of microseismic events is sporadic. Therefore, a suitable monitoring period is necessary and hence, portions of the recorded traces are occupied by pure noise. Second, the statistical knowledge (for designing the Wiener filter) of the microseismic event is unknown in advance. Noise is estimated blindly, i.e., without the wavelet transform (thus avoiding having to select a proper mother wavelet) or using the assumption that the noise-only portion of the data is available and known. Considering these two features, an observation-driven denoising procedure based on using an IIR Wiener filter is used in the present disclosure. The procedure entails estimating the statistics of the noise and the observation (signal plus noise) from the received data without any prior knowledge of the signal or the noise statistics. The filter gives promising results when applied to synthetic, semi-synthetic and field data sets at very low SNR of −12 dB, without assuming any specific type of noise. Thus it is suitable for denoising surface microseismic data with any type of noise, e.g., Gaussian, non-Gaussian, correlated, uncorrelated and coherent noise. The present disclosure presents a contribution to SNR enhancement with a data-driven IIR Wiener filter for microseismic data de-noising.

### SUMMARY

In an exemplary embodiment, a system for denoising microseismic data with an infinite impulse response (IIR) Weiner filter includes sensing, using M sensors placed over a monitoring area, microseismic events and receiving, by a receiver, the microseismic events. The receiver is connected to a computing device having circuitry configured for processing. The system continues by generating a set of microseismic traces from signals received over a sampling period and designing a IIR Weiner filter for each microseismic trace. Designing the IIR filter includes estimating each microseismic trace as a linear transformation of the microseismic signal, and estimating the IIR Weiner filter coefficients by minimizing a mean squared error cost function based on the received microseismic trace. The IIR Weiner filter is then used for denoising the microseismic traces to determine a denoised microseismic event.

In another exemplary embodiment, a method for denoising microseismic data with an infinite impulse response (IIR) Weiner filter, comprises generating a set of microseismic traces from signals received from microseismic sensors over a sampling period; receiving the set of microseismic traces at a computing device; designing a IIR Weiner filter for each microseismic trace, wherein designing the IIR filter includes estimating each microseismic trace as a linear transformation of the microseismic signal, estimating the IIR Weiner filter coefficients by minimizing a mean squared error cost function based on the received microseismic trace. The method continues by using the IIR Weiner filter for denoising the microseismic traces and determining a denoised microseismic event.

In another exemplary embodiment, a non-transitory computer readable medium having instructions stored therein that, when executed by one or more processor, cause the one or more processors to perform a method of denoising microseismic data by using an infinite impulse response (IIR) Weiner filter, comprising generating a set of microseismic traces from signals received from microseismic sensors over a sampling period; receiving the set of microseismic traces at a computing device; designing a IIR Weiner filter for each microseismic trace, wherein designing the IIR filter includes estimating each microseismic trace as a linear transformation of the microseismic signal and estimating the IIR Weiner filter coefficients by minimizing a mean squared error cost function based on the received microseismic trace. The method continues by using the IIR Weiner filter for denoising the microseismic traces and determining a denoised microseismic event.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a system for receiving and processing microseismic events, according to certain embodiments.

FIG. 1B is a plot of the amplitude for a noisy signal, according to certain embodiments.

FIG. 1C is a plot of the amplitude for an extremely noisy signal, according to certain embodiments.

FIG. 2 is an exemplary flowchart of the method for denoising the microseismic signals, according to certain embodiments.

FIG. 3 is an exemplary illustration of the synthetic data without noise, according to certain embodiments.

FIG. 4A is an exemplary illustration of the synthetic data with white Gaussian noise, according to certain embodiments.

FIG. 4B is an exemplary illustration of the synthetic data with correlated noise, according to certain embodiments.

FIG. 5A is a graph of the spectrum of correlated noise, according to certain embodiments.

FIG. 5B is a graph of the autocorrelation of the spectrum of FIG. 5A, according to certain embodiments.

FIG. 6A-6E are exemplary illustrations of the power spectrum of the noiseless synthetic data using short-time Fourier transform, showing (A) the event presence probability τ₁ of a noisy version of trace 1, (B) iteration 1, (C) iteration 2, (D) iteration 3, (E) iteration 4, according to certain embodiments.

FIG. 7A-7D are illustrations of iterations of the denoised synthetic data (A) Iteration 1, (B) Iteration 2, (C) Iteration 3, (D) Iteration 4, according to certain embodiments.

FIG. 8A-8D are illustrations of the denoised synthetic data: (A) method using white noise (B) enhanced method with stacking of adjacent traces using white noise, (C) method using correlated noise, (D) enhanced method with stacking of adjacent traces using correlated noise, according to certain embodiments.

FIG. 9 is a graph of noise level versus the number of iterations before denoising and after denoising.

FIG. 10A-10D are representations of the 4^{th} iteration results for a field data set (A) without noise, (B) with added white Gaussian noise, (C) denoised, (D) denoised using the enhanced method, according to certain embodiments.

FIG. 11A-11B are representations of the 4th iteration results with wavelet denoising for (A) noisy field data, (B) denoised field data, according to certain embodiments.

FIG. 12A-12B are representations of a field data set (A) before denoising, (B) after denoising, according to certain embodiments.

FIG. 13 shows hardware for the computing device used in the exemplary embodiments.

FIG. 14 illustrates a data processing system used in the exemplary embodiments.

FIG. 15 shows an implementation of a CPU of the computing device, according to certain embodiments.

FIG. 16 shows distributed components including one or more client and server machines, which may share processing.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

Seismic waves are reflected from areas of a geologic structure where a property, such as density or elasticity, of the geologic structure changes. Microseismic waves are very low level waves which may be caused by low level earthquakes, shifting of the strata during oil well drilling or fracturing, or any other disturbance of the substrate at a geologic location. The reflected waves are received by three component (3C) seismic sensors, which can take the form of geophones, hydrophones, acoustic sensors, seismometers, microphones, and any other device for receiving microseismic waves.

Noise received by seismic receivers from sources other than microseismic events must be filtered in order to obtain an accurate reading of the event. A Wiener filter is used to statistically estimate the desired signal from the noisy seismic trace, usually in the case of additive noise. Additive white Gaussian noise (AWGN) is a basic noise model used to mimic the effect of many random processes that occur in nature. It is additive because it is added to any noise that might be intrinsic to the information system. White refers to having uniform power across the frequency band. It is an analogy to the color white which has uniform emissions at all frequencies in the visible spectrum. It is Gaussian because it has a normal distribution in the time domain with an average time domain value of zero.

Typically, filters are designed for a specific frequency response. However, the design of a Wiener filter adopts a different approach. Inputs representing prior statistical knowledge of the desired signal and the noise (or the observation) are required and the filter is designed so that its output signal matches with the original desired signal as much as possible. With the proper design, a Wiener filter can be used to filter out the noise to get the underlying signal of interest.

In an aspect of the present disclosure, an Infinite Impulse Response (IIR) Wiener filter is designed without prior statistical knowledge of the desired signal and the noise as will be described below. Instead of prior statistical knowledge, autocorrelation of the received microseismic signals is performed to provide the IIR Wiener filter inputs. Autocorrelation, also known as serial correlation, is the correlation of a signal with a delayed copy of itself as a function of delay. Informally, it is the similarity between observations as a function of the time lag between them.

In a further aspect of the present disclosure, the microseismic traces are passed through a causal whitening filter before IIR Wiener filtering to rationalize the filter output. Embodiments to a system for denoising microseismic data with an infinite impulse response (IIR) Weiner filter, a method for denoising microseismic data with an infinite impulse response (IIR) Weiner filter and a non-transitory computer readable medium having instructions stored therein that, when executed by one or more processor, cause the one or more processors to perform a method system for denoising microseismic data with an infinite impulse response (IIR) Weiner filter are described.

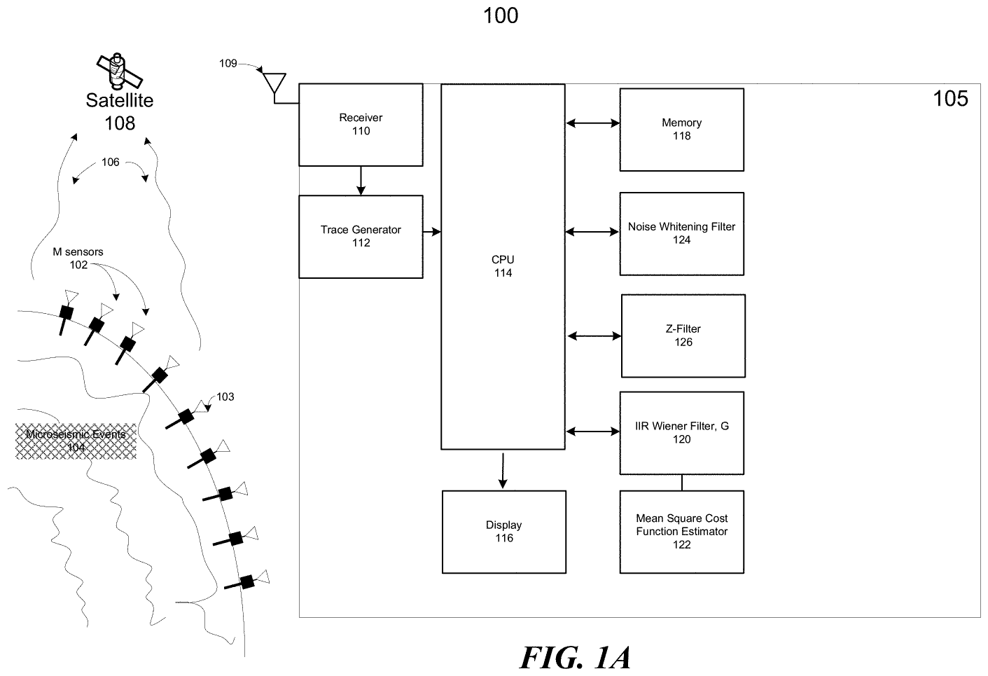

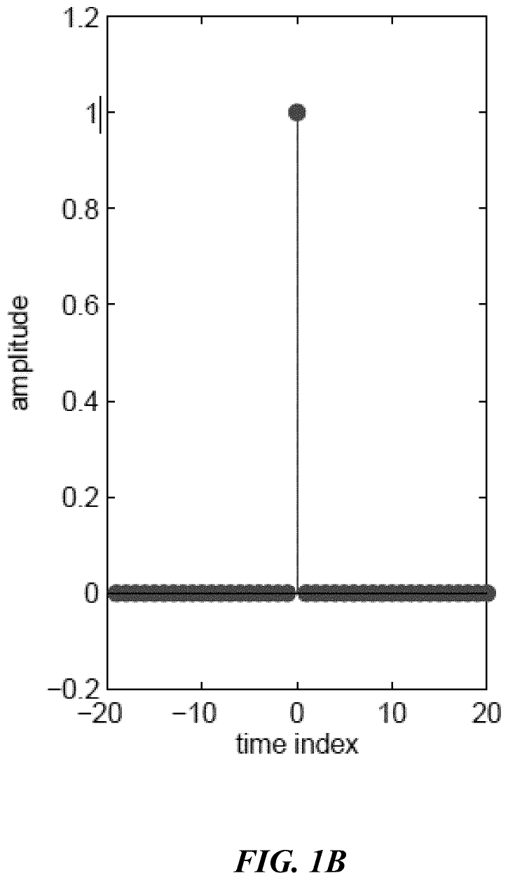

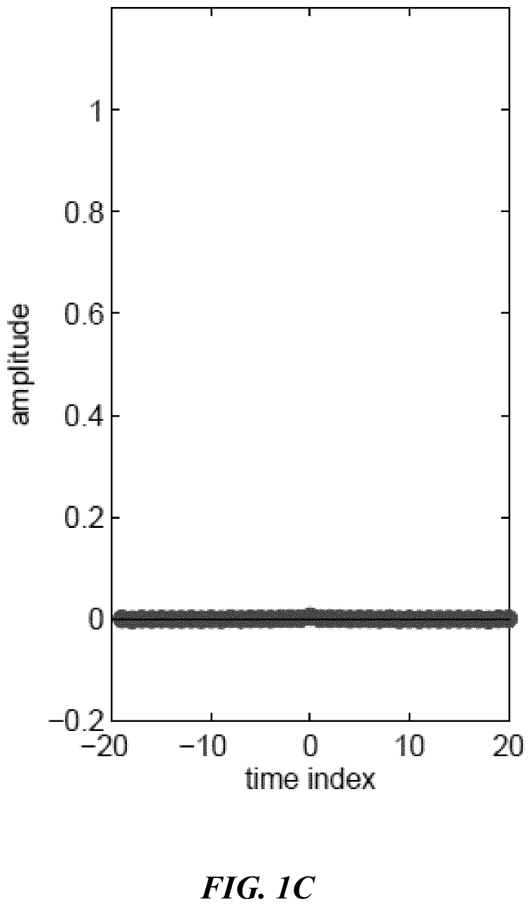

The first embodiment, illustrated in FIG. 1A, is a system for denoising microseismic event signals with an infinite impulse response (IIR) Weiner filter 120, comprising sensing, by M sensors placed at a geologic location, microseismic events.

M is a finite, integer number of sensors. M may be 1, 10, 100, 400, 1000, or any integer number greater than or equal to one and less than or equal to 1000. Each one of the M sensors 102 generates microseismic signals 106 in response to the microseismic events 104 and transmits, by a transmitter 103 operatively connected to each sensor 102, the microseismic signals to a remote, local or wired computing device. The M sensors are selected from the list comprising at least one of geophones, hydrophones, acoustic sensors, seismometers, microphones and the like.

In FIG. 1A, the sensors 102 are each shown transmitting the signals to a satellite 108, which transmits the signals to a computing device 105. However, the sensors may be wired together and transmit from an access point to a base station. Alternatively, the sensors may be directly wired to the receiver 110. Further, the system is not limited to transmission to a satellite. The transmission may be accomplished through a network, a cloud, the internet, a base station or any known means of transmitting data. The computing device 105 may be a physical computer, a web program, an online application, a smartphone app, or any computing device having instructions stored therein that, when executed by one or more processors, causes the one or more processors to perform denoising of microseismic data with an infinite impulse response (IIR) Weiner filter.

The computing device 105 includes an antenna 109 and a receiver 110 for receiving the microseismic signals. A trace generator 112, connected to the receiver, generates a set of microseismic traces from signals received from microseismic sensors during a sampling period (t). The set of microseismic traces is received by the central processing unit 114 of the computing device 105.

The computing device 105 has circuitry and program instructions configured for processing, and designs a IIR Weiner filter 120 for each microseismic trace, wherein designing the IIR filter includes estimating each microseismic trace as a linear transformation of the microseismic signal, estimating coefficients of the IIR Weiner filter by minimizing a mean squared error cost function, Jₖ, based on the received microseismic trace; and denoising, using the IIR Wiener filter, the microseismic trace, yₖ.

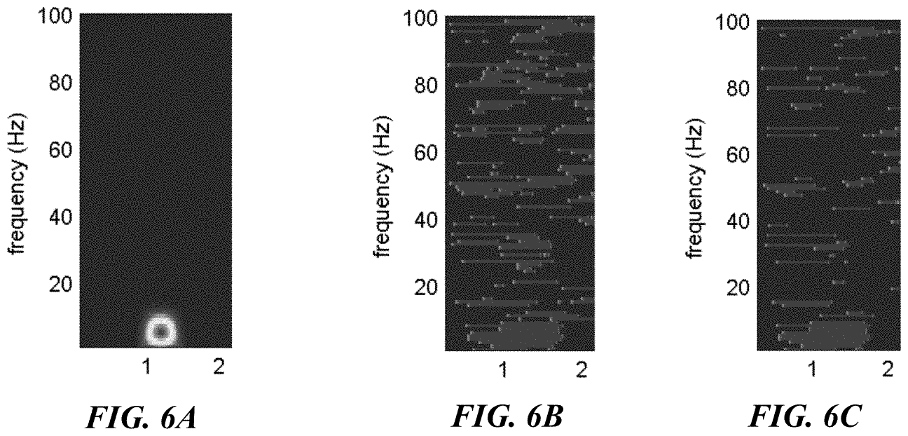

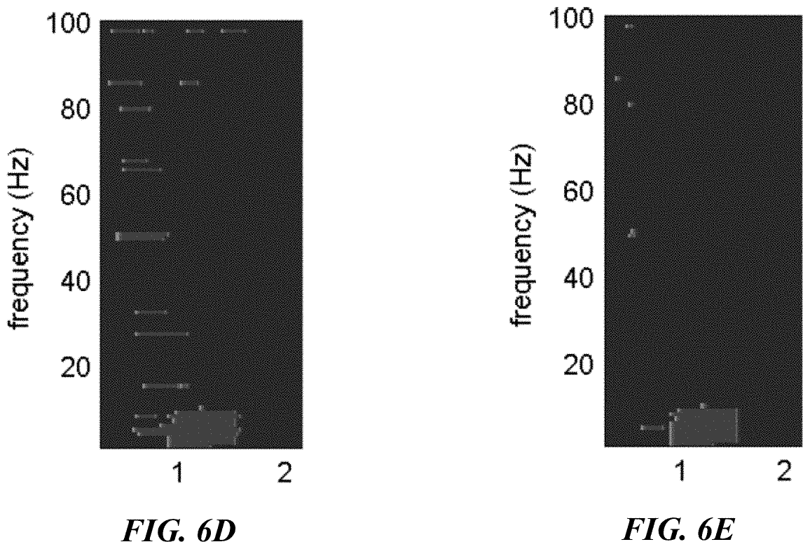

The denoised microseismic events may be displayed on display 116. Examples of experimental denoised traces are shown in FIG. 6E, 7D, 10A-10D, 12B for different data sets and additive noise types.

In the first embodiment, designing a IIR Wiener filter further comprises modelling each trace yₖ as a time series of noise components wₖ and a time series of noisy data components sₖ; concatenating yₖ, sₖ and wₖ into vectors; representing the filter for each trace as a time series of components g, where g=[g₀, g₁, g₂, . . . ] and estimating the filter coefficients by minimizing a mean squared error cost function Jₖ, where Jₖ=E{s̅ₖ s̅ₖ^{T}}, where s̅ₖ is an expected error in the signal sₖ, E is the mathematical expectation and T is the transposition operator, wherein minimizing the mean square cost function includes correlating s̅ₖ and yₖ such that E{s̅ₖyₖ^{T}}=0.

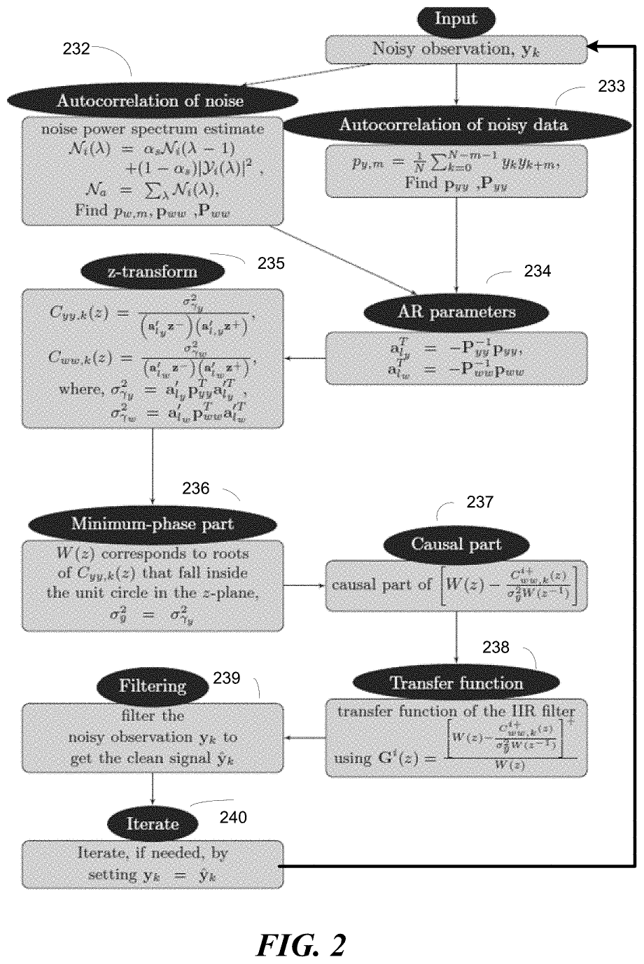

As shown in FIG. 2, the first embodiment further includes autocorrelating (232), by the computing device, the noise components wₖ with a delayed set of noise components wₖ₋₁; autocorrelating (233), by the computing device, the noisy data components sₖ with a delayed set of noisy data components sₖ₋₁; determining autoregressive (AR) parameters (234) for the noise and the noisy data; and using the results of the autocorrelation to improve the estimate of the IIR Weiner filter coefficients of the first denoised microseismic trace.

The system of the first embodiment further includes z-transforming (235), by the computing device, the autoregressive noise parameters and the autoregressive noisy data parameters (234) to generate to form a z-transform matrix C_{ww,k} representing the noise, and a z-transform matrix C_{yy,k} representing the noisy data; determining, by the computing device, the causal roots of C_{yy,k} which are less than a minimum threshold defined by a unit circle in the z-plane as shown at 236; forming a matrix W (237) of the causal roots; determining the transfer function G of the IIR Wiener filter (as shown at 238) by dividing, by the computing device, the z-transform matrix C_{ww,k} of the noise by the inverse of the matrix W multiplied by the variance squared, σ² of the microseismic trace yₖ, and subtracting the quotient from the matrix W, such that G=[(W−(C_{ww,k/}σ²W))/W]. The IIR Wiener filter 120 is applied at 238 to the noisy microseismic trace to denoise the microseismic trace and produce a denoised microseismic trace ŷₖ.

The first embodiment further includes filtering the set of microseismic traces by a white noise filter 120, V, before designing the IIR Wiener filter for each microseismic trace. After filtering with the IIR Wiener filter, G; the white noise filter, V, must be divided out to determine the denoised microseismic trace.

Additionally, the first embodiment includes stacking the autocorrelation results obtained from multiple microseismic traces for each of the noisy data and noise autocorrelations to improve the autocorrelation before determining the autoregressive (AR) parameters for the noise and the noisy data. Stacking the autocorrelation results is described in detail below.

The second embodiment, shown in FIG. 1A and FIG. 2, describes a method for denoising microseismic data with an infinite impulse response (IIR) Weiner filter 120, comprising sensing microseismic events 104 by M sensors 102 placed at a geologic location; generating microseismic signals 106 in response to the microseismic events by each of the M sensors and transmitting the microseismic signals to a computing device 105.

The method continues by receiving the microseismic signals at a receiver 110 of the computing device 105, the computing device having circuitry and program instructions configured for processing and analyzing signals and generating a set of microseismic traces from signals received from microseismic sensors during a sampling period (τ) by a trace generator 112 of the computing device.

The method continues by designing a IIR Weiner filter 120 for each microseismic trace, wherein designing the IIR filter includes estimating each microseismic trace as a linear transformation of the microseismic signal (see Z-filter 126) and estimating coefficients of the IIR Weiner filter by minimizing a mean squared error (122) cost function Jₖ based on the received microseismic trace and passing the microseismic trace through the IIR Weiner filter 120, thus denoising the microseismic trace yₖ.

The method further includes modelling each trace yₖ as a time series of noise components wₖ and a time series of noisy data components sₖ; concatenating yₖ, sₖ and wₖ into vectors; representing the filter for each trace as a time series of components g, where g=[g₀, g₁, g₂, . . . ]; estimating 122 the filter coefficients by minimizing a mean squared error cost function Jₖ, where Jₖ=E{s̅ₖ s̅ₖ^{T}}, where s̅ₖ is an expected error in the signal sₖ, E is the mathematical expectation and T is the transposition operator, wherein minimizing the mean square cost function includes correlating s̅ₖ and yₖ such that E{s̅ₖyₖ^{T}}=0.

As shown in FIG. 2, the method of the second embodiment continues by autocorrelating the noise components with a delayed set of noise components (232); autocorrelating the noisy data components with a delayed set of noisy data components (233); determining autoregressive (AR) parameters for the noise and the noisy data (234); and using the results of the autocorrelation to improve the estimate of the IIR Weiner filter coefficients of the first denoised microseismic trace.

The method further provides for z-transforming (235) the autoregressive noise parameters and the autoregressive noisy data parameters to generate to form a z-transform matrix C_{ww,k} representing the noise, and a z-transform matrix C_{yy,k} representing the noisy data; determining the causal roots of C_{yy,k} which are less than a minimum threshold defined by a unit circle in the z-plane (236); forming a matrix W of the causal roots (237); determining (238), the transfer function G of the IIR Wiener filter by dividing the z-transform matrix C_{ww,k} of the noise by the inverse of the matrix W multiplied by the variance squared, σ² of the microseismic trace yₖ, and subtracting the quotient from the matrix W, such that G=[(W−(C_{ww,k/}σ²W))/W]; applying the IIR Wiener filter (239) to the noisy microseismic trace to denoise the microseismic trace and produce a denoised microseismic trace ŷₖ. The result from the filtering step 239 can be sent back to the input step to iterate the denoising and provide a cleaner signal as is discussed below.

The method continues by filtering the set of microseismic traces by a white noise filter 126, V, before designing the IIR Wiener filter for each microseismic trace; filtering with the IIR Wiener filter 120, G; and dividing out the white noise filter, V, after filtering with the IIR Wiener filter, G, to denoise the microseismic trace.

The second embodiment of the method further includes stacking the autocorrelation results obtained from multiple microseismic traces for each of the noisy data and noise autocorrelations to improve the autocorrelation before determining the autoregressive (AR) parameters for the noise and the noisy data.

A third embodiment, shown in FIG. 1A and FIG. 2, is a non-transitory computer readable medium having instructions stored therein that, when executed by one or more processors, causes the one or more processors to perform a method for denoising microseismic data with an infinite impulse response (IIR) Weiner filter 120, comprises sensing microseismic events 104 by M sensors 102 placed at a geologic location; generating microseismic signals 106 in response to the microseismic events by each of the M sensors; transmitting, by transmitters 103, the microseismic signals to a computing device 105; receiving the microseismic signals at a receiver 110 of the computing device. The computing device has circuitry and program instructions configured for processing and analyzing signals; and is capable of generating a set of microseismic traces from signals received from microseismic sensors during a sampling period (τ) by a trace generator 112 of the computing device; designing a IIR Weiner filter 120 for each microseismic trace, wherein designing the IIR filter includes estimating each microseismic trace as a linear transformation, by Z-filter 126, of the microseismic signal and estimating coefficients of the IIR Weiner filter by minimizing a mean squared error cost function Jₖ based on the received microseismic trace by Mean Square Error Cost Function Generator 122 and denoising the microseismic trace yₖ by passing the trace through the IIR Wiener filter.

Designing a IIR Wiener filter further comprises modelling each trace yₖ as a time series of noise components wₖ and a time series of noisy data components sₖ; concatenating yₖ, sₖ and wₖ into vectors; representing the filter for each trace as a time series of components g, where g=[g₀, g₁, g₂, . . . ]; estimating the filter coefficients by minimizing a mean squared error cost function Jₖ, where Jₖ=E{s̅ₖ s̅ₖ^{T}}, where s̅ₖ is an expected error in the signal sₖ, E is the mathematical expectation and T is the transposition operator, wherein minimizing the mean square cost function includes correlating s̅ₖ and yₖ such that E{s̅ₖyₖ^{T}}=0.

The non-transitory computer readable medium method of the third embodiment is shown by FIG. 2 and further includes autocorrelating the noise components with a delayed set of noise components (232); autocorrelating the noisy data components with a delayed set of noisy data components (233); determining autoregressive (AR) parameters for the noise and the noisy data (234) and using the results of the autocorrelation to improve the estimate of the IIR Weiner filter coefficients of the first denoised microseismic trace.

The non-transitory computer readable medium method for denoising microseismic data further comprises z-transforming (235) the autoregressive noise parameters and the autoregressive noisy data parameters to generate to form a z-transform matrix C_{ww,k} representing the noise, and a z-transform matrix C_{yy,k} representing the noisy data; determining the causal roots of C_{yy,k} which are less than a minimum threshold defined by a unit circle in the z-plane (236); forming a matrix W of the causal roots (237); determining the transfer function G of the IIR Wiener filter by dividing the z-transform matrix C_{ww,k} of the noise by the inverse of the matrix W multiplied by the variance squared, σ² of the microseismic trace yₖ, and subtracting the quotient from the matrix W, such that G=[(W−(C_{ww,k/}σ²W))/W]; and applying the IIR Wiener filter to the noisy microseismic trace to denoise the microseismic trace and produce a denoised microseismic trace ŷₖ.

The non-transitory computer readable medium method continues by filtering the set of microseismic traces by a white noise filter 126, V, before designing the IIR Wiener filter for each microseismic trace; filtering with the IIR Wiener filter 120, G; and dividing out the white noise filter, V, after filtering with the IIR Wiener filter, G, to denoise the microseismic trace.

The result ŷₖ from the filtering step 239 can be sent back to the input step to iterate the denoising and provide a cleaner signal as is discussed below.

The third embodiment of the non-transitory computer readable medium method further includes stacking the autocorrelation results obtained from multiple microseismic traces for each of the noisy data and noise autocorrelations to improve the autocorrelation before determining the autoregressive (AR) parameters for the noise and the noisy data.

Further details of the estimation of the autocorrelation of the noise and the noisy observations from the recorded traces as needed for the filter are described below. Additionally, the method of the present disclosure is compared using synthetic and field data sets.

In the present disclosure, the IIR Wiener filter is designed without prior statistical knowledge. To clarify this technique, let A, B and C be the desired signal, the noisy signal and the output of the IIR Wiener filter, respectively. Mathematically, the error eᵣ can be written as

eᵣ=C−A.

The Wiener filter is designed by minimizing the mean-square error, i.e.,

min E{eᵣ²},

where E is the mathematical expectation. (See Proakis, J. (1985). Probability, random variables and stochastic processes. IEEE Transactions on Acoustics, Speech, and Signal Processing, 33(6):1637-1637, incorporated herein by reference in its entirety).

In signal processing and mathematics, a discrete-time signal, which is a sequence of complex or real numbers, can be converted to a complex frequency domain representation using the z-transform. This is equivalent to the Laplace transform in continuous-time. (For more details about the Wiener filter and z-transform. See Haykin, S. (2002). Adaptive Filter Theory. Prentice Hall, Upper-Saddle River, N.J., 4th edition; Proakis, J. G. and Manolakis, K. D. (2006). Digital Signal Processing. Prentice-Hall, Inc. Upper Saddle River, N.J., USA, 4th edition; and Sayed, A. H. (2008). Adaptive Filters. John Wiley and Sons, Inc., Hoboken, N.J., USA, each incorporated herein by reference in their entirety).

In the present disclosure, an IIR Wiener filter is designed to estimate the microseismic signal from the noisy records. The analysis is carried out through the use of the z-transform. The filter coefficients of the IIR Wiener filter must be derived for the filter to be designed.

M sensors 102 (See FIG. 1A) are placed over a monitoring area for recording microseismic data. The sensors may be wired or wireless, having an antenna for uploading measurements to a satellite for transmission to a remote control station 105. Each sensor may have its own antenna, or the sensors 102 may be wired together and data may be collected from each sensor and transmitted by an access point to the remote control station through any of the internet, a network cloud, to a satellite, etc. Alternatively, the microseismic events may be recorded by the sensors and later downloaded for analysis by physical connection to control station 105. A non-limiting example of the type of sensor suitable for recording microseismic events is the DT-Solo sensor manufactured by DTCC Dynamic Technologies, http://smartsolo.com/wp-content/uploads/2017/11/smartsolo_brochure_web.pdf Each of these sensors records a time series of sampled measurements, i.e., a micro-seismic trace, yₖⁱ, which can be represented as

yₖⁱ=sₖⁱ+|wₖⁱ,i=1,2, . . . ,M, (1)

where sₖⁱ and wₖⁱ represent the signal and noise sample, respectively, at time instant t=kT of the i^{th} trace (T is the sampling interval). The time series yₖⁱ, sₖⁱ and wₖⁱ are concatenated into vectors as follows:

yₖⁱ=[yₖⁱ,yₖ₋₁ⁱ,yₖ₋₂ⁱ, ⋅ ⋅ ⋅ ]^{T}, (2)

sₖⁱ=[sₖⁱ,sₖ₋₁ⁱ,sₖ₋₂ⁱ, ⋅ ⋅ ⋅ ]^{T}, (3)

wₖⁱ=[wₖⁱ,wₖ₋₁ⁱ,wₖ₋₂ⁱ, ⋅ ⋅ ⋅ ]^{T}, (4)

In the derivation of the coefficients, real numbers are assumed. The methods of the present disclosure design an IIR filter gⁱ for each trace to estimate the signal sₖⁱ as a linear transformation of the measurement yₖⁱ. The output of the filter is given as

ŝₖⁱ=gⁱyₖⁱ, (5)

where gᵢ=[g₀ⁱ,g₁ⁱ,g₂ⁱ, . . . ]. The filter is mathematically of an infinite length duration as is the data sequence. To estimate the filter coefficients, the Mean Squared Error (MSE) cost function Jₖⁱ, is minimized according to

Jₖⁱ=E{\tilde{s}ₖⁱ\tilde{s}ₖ^{iT}}, (6)

where the estimation error is \tilde{s}ₖⁱ=sₖⁱ−ŝₖⁱ, and E{.} and (.)^{T} represent the mathematical expectation (that gives the most expected value, i.e., the predictor) and the transposition operation, respectively. Minimizing the MSE is equivalent to finding the solution by considering the error to be orthogonal to each of the data points in the estimation process. Equation (6) can be solved directly using the correlation of \tilde{s}ₖⁱ and yₖⁱ which gives:

$$\begin{matrix}E \{ {\tilde{s}}_{k}^{i} {y}_{k}^{iT} \} = E \{ [ {s}_{k}^{i} - {\hat{s}}_{k}^{i} ] {y}_{k}^{iT} \} \\ = E \{ {s}_{k}^{i} {y}_{k}^{iT} - {g}^{i} {y}_{k}^{i} {y}_{k}^{iT} \} \\ = E \{ {y}_{k}^{i} {y}_{k}^{iT} - {w}_{k}^{i} {y}_{k}^{iT} - {g}^{i} {y}_{k}^{i} {y}_{k}^{iT} \} \\ = E \{ {y}_{k}^{i} {y}_{k}^{iT} - {w}_{k}^{i} {y}_{k}^{iT} - {w}_{k}^{i} {w}_{k}^{iT} - {g}^{i} {y}_{k}^{i} {y}_{k}^{iT} \} \\ = {P}_{yy , k}^{i} - {P}_{ws , k}^{i} - {P}_{ww , k}^{i} - {g}^{i} {P}_{yy , k}^{i} ,\end{matrix} \qquad ( 7 )$$

where p_{ab,k}ⁱ denotes the correlation between signals a and b of the i^{th} trace. Assuming that the noise and the signal are uncorrelated, i.e., p_{ws,k}ⁱ=0, (7) becomes:

E{\tilde{s}ₖⁱyₖ^{iT}}−p_{yy,k}ⁱ−p_{ww,k}ⁱ−gⁱP_{gg,k}ⁱ, (8)

According to the principle of orthogonality, i.e., the estimate ŝₖⁱ, that minimizes the MSE cost function Jₖⁱ of Eq. (6), is the orthogonal projection of \tilde{s}ₖⁱ into the space spanned by the observations. This is equivalent to requiring E{\tilde{s}ₖⁱyₖ^{iT}}=0, which yields

gⁱP_{yy,k}ⁱ=p_{yy,k}ⁱ−p_{ww,k}ⁱ. (9)

Since Eq. (9) holds for an infinite length of filter, it cannot be solved directly using a set of linear equations nor it can be solved using the z-transform because the Wiener filter is causal, i.e., gₖⁱ=0 for k<0. Causal data is defined as data determined from prior and current data. To address this issue, the noisy observation yₖⁱ is represented by another equivalent process, y̅ₖⁱ, by passing it through a noise-whitening filter.

Mathematically, this yields

$${\overline{y}}_{k}^{i} = {v}^{i} {y}_{k}^{i} = \underbrace{{v}^{i} {s}_{k}^{i}}_{{\overline{s}}_{k}^{i}} + {\underbrace{{v}^{i} {w}_{k}^{i}}}_{{\overline{w}}_{k}^{i}} . \qquad ( 10 )$$

where vⁱ=[v₀ⁱ,v₁ⁱ,v₂ⁱ, . . . ] is the impulse response of the whitening filter. Now ŝₖⁱ can be written as

ŝₖⁱ=qⁱy̅ₖⁱ, (11)

where qⁱ=[q₀ⁱ,q₁ⁱ,q₂ⁱ, . . . ]. The IIR Wiener filter can be seen as a cascade of the whitening filter Vⁱ(z) and another filter Qᵢ(z) in the z-domain, where Vⁱ(z){Qⁱ(z)} is the z-transform of vⁱ{qⁱ}. Application of the principle of orthogonality, E{\tilde{s}ₖⁱy̅ₖ^{iT}}=0, leads to

qⁱP_{ÿÿ,k}ⁱ=p_{yÿ,k}ⁱ−p_{w\ddot{w},k}ⁱ. (12)

In probability theory and statistics, variance, σ, is the expectation of the squared deviation of a random variable from its mean. Informally, it measures how far a set of (random) numbers are spread out from their average value.

Since y̅ₖⁱ is white, therefore,

$${P}_{\overline{yy} . k}^{i}$$

is a diagonal matrix with

$${σ}_{\overline{y}}^{2}$$

as diagonal entries and Eq. (12) becomes

$${q}^{i} = \frac{1}{{σ}_{\overline{y}}^{2}} ( {p}_{y \overline{y} , k}^{i} - {p}_{w \overline{w} , k}^{i} ) . \qquad ( 13 )$$

Now define the z-domain as z⁺=[1, z¹, z², . . . ] and z⁻=[1, z⁻¹, z⁻², . . . ]. Hence, Eq. (13) in the z-domain is

$${Q}^{i} ( z ) = \frac{1}{{σ}_{\overline{y}}^{2}} \underbrace{{{z}^{-} ( {p}_{y \overline{y} , k}^{i} - {p}_{w \overline{w} , k}^{i} )}^{T}}_{{C}_{\overline{y} \overline{w} , k}^{i +} ( z )} . \qquad ( 14 )$$

$${C}_{\overline{yw} , k}^{i +} ( z )$$

represents me z-transform of the one-sided autocorrelation sequence

$${p}_{y \overline{y} , k}^{i} - {p}_{w \overline{w} , k}^{i}$$

and,

$$\begin{matrix}{p}_{y \tilde{y} , k}^{i} - {p}_{w \tilde{w} , k}^{i} = E \{ {y}_{k}^{i} {\overline{y}}_{k}^{iT} - {w}_{k}^{i} {\overline{w}}_{k}^{iT} \} \\ = {[ {v}^{i} E \{ {( {y}_{k}^{i} {y}_{k}^{iT} - {w}_{k}^{i} {w}_{k}^{iT} )}^{T} \} , {v}^{i} E \{ {( {y}_{k}^{i} {y}_{k - 1}^{iT} - {w}_{k}^{i} {w}_{k - 1}^{iT} )}^{T} \} , … ]}^{T} \\ = {[ {{v}^{i} ( {p}_{yy , k}^{i} - {p}_{ww , k}^{i} )}^{T} , {{v}^{i} ( {p}_{yy , k + 1}^{i} - {p}_{ww , k + 1}^{i} )}^{T} , … ]}^{T} .\end{matrix} \qquad ( 15 )$$

Taking the z-transform of Eq. (15) yields

$$\begin{matrix}{C}_{\overline{y} \overline{w} , k}^{i} ( z ) = {z [ … , {{v}^{i} ( {p}_{yy , k - 1}^{i} - {p}_{ww , k - 1}^{i} )}^{T} , {{v}^{i} ( {p}_{yy , k}^{i} - {p}_{ww , k}^{i} )}^{T} , {{v}^{i} ( {p}_{yy , k + 1}^{i} - {p}_{ww , k + 1}^{i} )}^{T} , … ]}^{T} \\ = {{v}^{i} [ … , {z ( {p}_{yy , k - 1}^{i} - {p}_{ww , k - 1}^{i} )}^{T} , {z ( {p}_{yy , k}^{i} - {p}_{ww , k}^{i} )}^{T} , {z ( {p}_{yy , k + 1}^{i} - {p}_{ww , k - 1}^{i} )}^{T} , … ]}^{T} \\ = {z}^{+} {v}^{iT} {z ( {p}_{yy , k}^{i} - {p}_{ww , k}^{i} )}^{T} \\ = {V}^{i} ( {z}^{- 1} ) ( {C}_{yy , k}^{i} ( z ) - {C}_{ww , k}^{i} ( z ) ) .\end{matrix} \qquad ( 16 )$$

Using spectral decomposition, C_{yy,k}ⁱ(z) can be written as

C_{yy,k}ⁱ(z)=σ_{ÿ}²W(z)W(z⁻¹). (17)

W(z) is the minimum-phase part, which is analytic in the region |z|>r and r<1. With spectral factorization the whitening filter becomes Vⁱ(z)=1/W(z). Therefore,

$${C}_{\overline{y} \overline{w}}^{i +} ( z ) = {[ \frac{{C}_{yy , k}^{i} ( z ) - {C}_{ww , k}^{i} ( z )}{W ( {z}^{- 1} )} ]}^{+} = {[ {σ}_{ij}^{2} W ( z ) - \frac{{C}_{ww , k}^{i} ( z )}{W ( {z}^{- 1} )} ]}^{+} . \qquad ( 18 )$$

### Now,

$${Q}^{i} ( z ) = {[ W ( z ) - \frac{{C}_{ww , k}^{i} ( z )}{{σ}_{y}^{2} W ( {z}^{- 1} )} ]}^{+} . \qquad ( 19 )$$

and finally,

$${G}^{i} ( z ) = \frac{{Q}^{i} ( z )}{W ( z )} = \frac{{[ W ( z ) - \frac{{C}_{ww , k}^{i} ( z )}{{σ}_{y}^{2} W ( {z}^{- 1} )} ]}^{+}}{W ( z )} . \qquad ( 20 )$$

In short, to design an IIR Wiener filter, spectral factorization of C_{yy,k}ⁱ(z) must be done to obtain the minimum-phase part W(z) and finally solve for the causal part of

[W(z)−C_{ww,k}ⁱ(z)/σ2/yW(z⁻¹)].

The SNR is commonly defined as

$$SNR = \frac{{σ}_{s}^{2}}{{σ}_{w}^{2}} , \qquad ( 21 )$$

where σₛ² and σ_{w}² are the signal and noise powers, respectively. Using this definition, the following interpretation of the IIR Wiener filter in terms of the SNR can be deduced by considering the two limiting cases of a noise-free signal and an extreme noisy signal, that respectively are given by

$$\begin{matrix}{lim}_{SNR \to ∞} {G}^{i} ( z ) = 1 , & ( 22 ) \\ {lim}_{SNR \to 0} {G}^{i} ( z ) = 0. & ( 23 )\end{matrix}$$

The justification of Eq. (22) and Eq. (23) is as follows. When SNR→∞, this corresponds to zero noise content and therefore σ_{w}²=0 and similarly C_{ww,k}ⁱ(z)=0, and consequently Gⁱ(z)=1. However, when SNR→0, this corresponds to a zero signal content, i.e., σₛ²=0, which results in

$${σ}_{\overline{y}}^{2} = {σ}_{\overline{w}}^{2} and {C}_{ww , k}^{i} ( z ) = {σ}_{\overline{y}}^{2} W ( z ) W ( {z}^{- 1} )$$

and consequently Gⁱ(z)=0. This means that at a very high SNR, the filter applies very little or no attenuation to the noise-free signal, whereas when there is only noise, the filter enters the stop band region, i.e., does not allow the input signal (which is only noise) to pass through; since the filter response is Gⁱ(z)=0. In the time-domain, Gⁱ(z)=1 corresponds to g₁ⁱ=1 and Gⁱ(z)=0 corresponds to gₙⁱ=0,∀n. The plot for the two cases highlighted above (Eq. (22) and Eq. (23)) is shown in FIG. 1A and FIG. 1B. To see the response of the filter, for SNR→∞, the Ricker wavelet of center frequency 30 Hz without noise is used and for SNR→0, only noise is used.

Now the estimation of the autocorrelation sequence of the observation and its corresponding z-transform in practical scenarios are detailed. To estimate the autocorrelation of the noisy observation (and ultimately the z-transform), first the noisy observation is modeled as an Auto-Regressive (AR) process. For this purpose, the following model is used for the observed data y at instant k

yₖ=−aₗ_{_{y}}yₖ₋₁+γₖ, (24)

where aₗ_{_{y}}=[a₁, a₂, . . . , aₖ₋₁]^{T} are AR coefficients (l is the number of coefficients), yₖ₋₁=[yₖ₋₁, yₖ₋₂, . . . , yₖ₋₁]T and γₖ is the white noise with zero mean and variance σ_{γ}_{_{y}}². To find aₗ_{_{y}}, Eq. (24) is post multiplied with

$${y}_{k - 1}^{T}$$

and the mathematical expectation is taken, which yields

E{ykyₖ₋₁^{T}}=−E{aₗ_{_{y}}yₖ₋₁yₖ₋₁^{T}}+E{yₖ₋₁^{T}γk}. (25)

Assuming that data and noise are uncorrelated and the noise has zero mean, Eq. (25) becomes

−p_{yy}=P_{yy}aₗ_{_{y}}^{T}, (26)

and aₗ_{_{y}}^{T} is calculated as

aₗ_{_{y}}^{T}=−P_{yy}⁻¹p_{yy}, (27)

where p_{yy}=[p_{y},1, p_{y},2, . . . p_{y},1]^{T}, P_{yy}=Toeplitz([p_{y},0, p_{y},1, . . . p_{y}, l−1], [p_{y},0, p_{y},−1, . . . p_{y},−l+1]), and p_{y,m}=p_{y,-m}. The first column and the first row of the Toeplitz matrix p_{yy} are [p_{y}, 0, p_{y}, 1, . . . p_{y}, l−1] and [p_{y}, 0, p_{y}, −1, . . . p_{y}, −l+1], respectively. To ensure that the autocorrelation matrix in Eq. (27) is positive definite, a biased form of the estimator is used for p_{y,m}, i.e,

$${p}_{y , m} = \frac{1}{N} {Σ}_{k = 0}^{N - m - 1} {y}_{k} {y}_{k + m} , m = 0 , 1 , … , l - 1 ,$$

where N is the number of samples in the trace. This estimator results in a stable AR model. In order to avoid inversion in Eq. (27), the Levinson-Durbin algorithm can be used, which is a recursive and computationally efficient method that utilizes the Toeplitz structure of the correlation matrix. After finding aₗ_{_{y}}, then the z-transform of the autocorrelation sequence can be found as follows. Equation (24) can be rewritten as

aₗ_{_{y}}′yₖ=γₖ, (28)

where a′ₗ_{_{y}}=[1, a₁, a₂, . . . , aₗ] and yₖ=[yₖ, yₖ₋₁, . . . yₖ₋₁]^{T}. Now, taking the z-transform of Eq. (28), yields

Y(z)(aₗ_{_{y}}′z⁻)=γ(z). (29)

Multiplying each side of this equation by its respective time-reversed version gives

C_{yy,k}(z)(aₗ′z⁻)(aₗ′z⁺)=σ_{γ}_{_{y}}². (30)

In this way, the noisy observation is modeled by an AR process and the respective z-transform of the autocorrelation sequence can be obtained as

$${C}_{yy , k} ( z ) = \frac{{σ}_{{γ}_{y}}^{2}}{( {a}_{{l}_{y}}^{′} \vert {z}^{-} ) ( {a}_{{l}_{y}}^{′} {z}^{+} )} . \qquad ( 31 )$$

Now, σ_{γ}_{_{y}}² can be found by multiplying Eq. (28) by its complex conjugate (*) and taking the mathematical expectation, and since γₖ is a real-valued number, therefore, E{|γₖ|²}=σ_{γ}_{_{y}}². Now from Eq. (28)

E{γₖγₖ*}=E{aₗ_{_{y}}′,yₖyₖ^{T}aₗ_{_{y}}′^{T}}, (32)

σ_{γ}_{_{y}}²=aₗ_{_{y}}′E{yₖyₖ^{T}}aₗ_{_{y}}^{iT}, (33)

σ_{γ}_{_{y}}²=aₗ_{_{y}}′p_{yy}aₗ_{_{y}}^{iT}. (34)

From Eq. (31), it is clear that C_{yy,k}(z) can be found using the knowledge of aₗ_{_{y}} and σ_{γ}_{_{y}}². This yields the estimation of the z-transform of the observation autocorrelation sequence.

Estimating the noise autocorrelation matrix consists of five steps, namely, the initial power spectrum estimation, the minimum tracking, the event detection, the smoothing factor calculation and the noise spectrum update. The steps are detailed next.

The smoothed power spectrum of the noisy data is estimated using the first order recursive relation as follows,

[symbol]

ᵢ(λ)=η [symbol] ᵢ(λ−1)+(1−η)═yᵢ(λ)|², (35)

where [symbol] is the short-time Fourier transform of the noisy data, η is the forgetting factor (which gives less weight to older samples) and λ is the frame index. (See Doblinger, G. (1995). Computationally Efficient Speech Enhancement By Spectral Minima Tracking In Subbands. in Proc. Eurospeech, pages 1513-1516, incorporated herein by reference in its entirety.) The power spectrum | [symbol] |² is obtained by taking the absolute value of each element and squaring it. The size of [symbol] is N̅ and the step size (or hop size) to calculate the short-time Fourier transform is h.

The minimum of the noisy data is tracked by a non-linear approach that averages the past values continuously as follows:

$${𝒫}_{i , min} ( λ ) = [ {𝒫}_{i , min} ( λ - 1 ) < {𝒫}_{i} ( λ ) ] ⊙ [ {γ𝒫}_{i , min} ( λ - 1 ) + \frac{1 - γ}{1 - β} ( {𝒫}_{i} ( λ ) - β {𝒫}_{i} ( λ - 1 ) ) ] + [ {𝒫}_{i , min} ( λ - 1 ) > {𝒫}_{i} ( λ ) ] ⊙ {𝒫}_{i} ( λ ) , \qquad ( 36 )$$

where [P_{i,min}(λ−1)<Pᵢ(λ)] represents element-by-element comparison and its resultant vector contains 1s (if condition is true) and 0s (otherwise), “⊙” denotes the Hadamard product (element-by-element multiplication) and P_{i,min}(λ−1) is the local minimum of the noisy data power spectrum. γ and β are the adaptation constants that are determined experimentally.

To detect the presence of microseismic events, the ratio of the noisy data spectrum to its local minimum, Sᵢ(λ), is defined as

[symbol]

ᵢ(λ)= [symbol] ᵢ(λ)└ [symbol] _{i,min}(λ), (37)

where “Ø” represents the element-by-element division. (See Cohen, I. and Berdugo, B. (2002). “Noise estimation by minima controlled recursive averaging for robust speech enhancement”. IEEE Signal Processing Letters, 9(1):12-15, incorporated herein by reference in its entirety.) The ratio is based on the fact that the power spectrum of the noisy trace will be nearly equal to its local minimum when microseismic event is absent. The smaller the ratio in Eq. (37), the higher the probability that the event is absent. The ratio is compared with a frequency-dependent threshold δ and consequently, the event presence probability Iᵢ(λ) is updated, using first-order recursion,

[symbol]

ᵢ(λ)=αₚ [symbol] ᵢ(λ−1)+(1−αₚ)[ [symbol] ᵢ(λ)>δ)], (38)

where [Sᵢ(λ)>δ)] represents a comparison of each element in Sᵢ(λ) with the frequency-dependent threshold δ (to be discussed later in the results section) and its result is a vector with 1s (if condition is true) and 0s (otherwise). The quantity αₚ is a smoothing constant. The recursion in Eq. (38) implicitly exploits the correlation among the frames for detecting the event.

The time-frequency dependent smoothing factor is computed

α₈=α_{d}+(1−α_{d}) [symbol] ᵢ(λ). (39)

where α_{d} is a constant and α₈ is a time-varying smoothing parameter. Note that α₈ has values in the range of α_{d}≤α₈≤1.

Finally, the noise power spectrum estimate [symbol] ᵢ(λ) is updated according to

[symbol]

(λ)=α₈ [symbol] (λ−1)+(1−α₈)|yᵢ(λ)|². (40)

The above procedure is done for all frequency bins. Note that constants (mixing parameters) η, γ, β, αₚ and α_{d} can easily be determined experimentally and their values lie between 0 and 1. The overall algorithm can be summarized as follows. After classifying the frequency bins as event absent/present, the event-presence probability is updated using Eq. (38). Using this probability, the time-frequency dependent smoothing factor is updated as in Eq. (39). Finally, the noise power spectrum is estimated using update Eq. (40). After obtaining the noise power spectrum estimate, it is averaged over all λ's, i.e, [symbol] ₐ=Σ_{λ} [symbol] ᵢ(λ) and converted back to the time-domain, which gives the noise autocorrelation estimate p_{w,0}, p_{w,1}, . . . , p_{w,l-1}. Then, from these estimates, p_{ww} and P_{ww} are found (as done for p_{yy} and P_{yy}). To find the z-transform of the noise autocorrelation sequence, the procedure outlined in Section 3 has been used.

A summary of the method and enhancements for estimating the correlation matrices follows.

A flowchart of the denoising method is shown in FIG. 2 and can be summarized as follows:

Step 1. Find the autocorrelation of noisy data and noise using

$${p}_{y , m} = \frac{1}{N}$$

Σₖ₌₀^{N-m-1}yₖyₖ₊ₘ, and

$${p}_{w , m} = \frac{1}{N} {\sum }_{k = 0}^{N - m - 1} {w}_{k} {w}_{k + m} , m \geq 0 ,$$

respectively, and then form p_{yy}, P_{yy}, p_{ww}, and P_{ww} for each trace.

Step 2. Find the AR parameters for the noisy observation and the noise using aₗ_{_{y}}^{T}=−P_{yy}⁻¹p_{yy} and a_{lw}^{T}=−P_{ww}⁻¹p_{ww}, respectively.

Step 3. Find the z-transform of the autocorrelation sequence for the observed data and the noise as

$${C}_{yy , k} ( z ) = \frac{{σ}_{{γ}_{y}}^{2}}{( {a}_{{l}_{y}}^{′} z - ) ( {a}_{{l}_{y}}^{′} z + )} and {C}_{ww , k} ( z ) = \frac{{σ}_{{γ}_{w}}^{2}}{( {a}_{{l}_{w}}^{′} z - ) ( {a}_{{l}_{w}}^{′} z + )} ,$$

respectively, where σ_{γ}_{_{y}}²=a′ₗ_{_{y}}p_{yy}^{T}a′ₗ_{_{y}}^{T}, and σ_{γ}_{_{w}}²=a′ₗ_{_{w}}p_{ww}^{T}a′ₗ_{_{w}}^{T}.

Step 4. Find W(z) by calculating the roots of C_{yy,k}(z) that fall inside the unit circle in the z-plane and

$$σ \frac{2}{y} = {σ}_{{γ}_{y}}^{2} .$$

Step 5. Find the causal part of

$$[ W ( z ) - \frac{{C}_{ww , k}^{i +} ( z )}{σ \frac{2}{y} W ( {z}^{- 1} )} ] .$$

Step 6. Find the transfer function of the IIR filter using

$${G}^{i} ( z ) = \frac{[ W ( z ) - \frac{{c}_{ww , k}^{i +} ( z )}{σ \frac{2}{y} W ( {z}^{- 1} )} ]}{W ( z )}$$

and filter the noisy observation to get the clean signal.

Step 7. The procedure is repeated in an iterative fashion to obtain a clearer signal.

In FIG. 2. For simplicity of the notation, the superscript i (that corresponds to the i^{th} trace) is omitted, and the work flow is the same for all traces.

Assuming that the noise has a similar autocorrelation (or power spectral density in frequency-domain) for various traces, the estimation of the autocorrelation sequences for data and noise can be improved by stacking over the adjacent traces and/or components as in the case of 3C sensors. (See Caffagni et al., 2016; Cieplicki, R., Mueller, M., and Eisner, L. (2014). “Microseismic event detection: Comparing P-wave migration with P- and S-wave cross-correlation”. In SEG Technical Program Expanded Abstracts 2014, pages 2168-2172. Society of Exploration Geophysicists, each incorporated herein by reference in their entirety).

First, the autocorrelation of noisy data and noise are found using

$${p}_{y , m}^{ij} = \frac{1}{N} {\sum }_{k = 0}^{N - m - 1} {y}_{k}^{ij} {y}_{k {+}^{ij} m} and$$

$${p}_{w , m}^{ij} = \frac{1}{N} {\sum }_{k = 0}^{N - m - 1} {w}_{k}^{ij} {w}_{k {+}^{ij} m} m \geq 0 ,$$

respectively, for i^{th} trace and j^{th} component of a 3C sensor. Second, after finding these autocorrelations for all the traces, the autocorrelations are stacked to improve the estimation, i.e.,

$${p}_{w , m} = \frac{1}{3 M} {\sum }_{j = 1}^{3} {\sum }_{i = 1}^{M} {p}_{w , m}^{ij} , \qquad ( 41 )$$

A similar procedure is used for estimating the autocorrelation of observation, i.e.,

$${p}_{y , m} = \frac{1}{3 M} {\sum }_{j = 1}^{3} {\sum }_{i = 1}^{M} {p}_{y , m}^{ij} , \qquad ( 42 )$$

After finding the autocorrelation of the noisy data p_{y,m}, and noise p_{w,m}, the autocorrelation matrices p_{yy}, P_{yy}, p_{ww}, and P_{ww} are formed and the rest of the procedure is the same as detailed above.

Importantly, in the enhancement method of the present disclosure, the traces are not stacked prior to the autocorrelation but the autocorrelations of the traces are stacked, i.e., first the autocorrelations are found for each trace followed by the stacking of the autocorrelations. The autocorrelations don't need to be aligned as they are already aligned. The estimation improves if traces have similar power spectral densities, i.e., traces have white noise or Brownian noise etc. Traces may have the similar power spectral densities but different noise levels (variances), however the system and methods of the present disclosure compensate automatically for the difference in the variances. The IIR wiener filter is the ratio of two autocorrelations. Hence, if the noise level changes the level of the noisy observation also changes and so does the magnitude of the autocorrelations of the noisy observation and noise (as the autocorrelations are derived from the traces). Since the filter is a ratio of autocorrelations (Eq. 13) or power spectral densities (Eq. 20) it will compensate for the effect. If a bias is present due to a broken channel, the bias will be compensated and will not affect the results.

In summary, the denoising procedure estimates the autocorrelation in a trace-by-trace manner, and the enhancement procedure improves the estimation of the autocorrelation by averaging over the adjacent traces. The improvement of the autocorrelation sequence estimation is referred to as the enhanced method.

Testing of the IIR Wiener filter on synthetic, semi-synthetic and field data follows. To test the robustness of the procedure, two types of noise are used (correlated and uncorrelated noise).

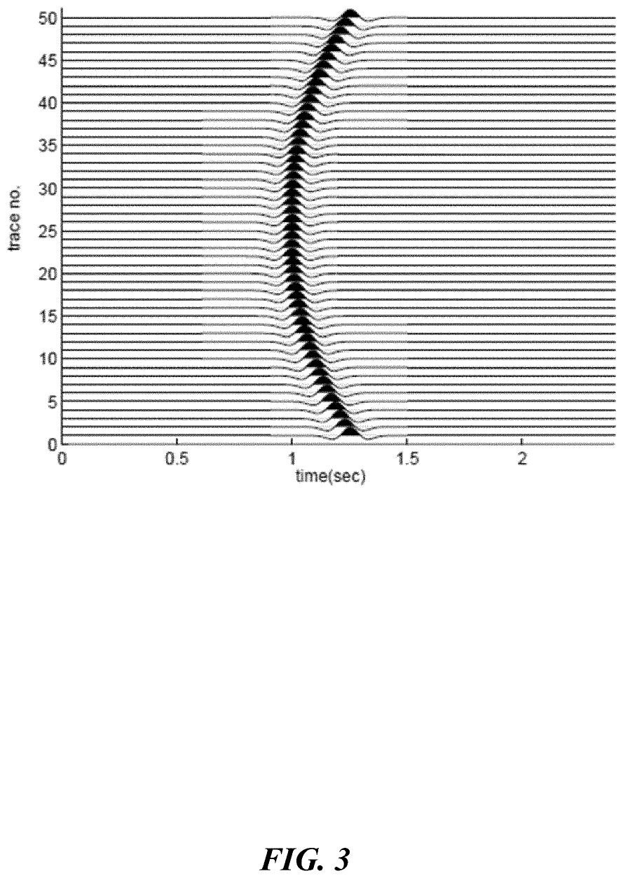

For the synthetic (test) data set, a Ricker wavelet with a center frequency of 5 Hz is used as the microseismic source signature to generate the data set. Fifty receivers are placed in a line and the middle receiver is assumed to be the closest to the source. Moreover, a constant medium velocity is assumed and the sampling frequency is set to 1 kHz. The resulting data is depicted in FIG. 3. The number of AR coefficients is set to l=10 for all the data sets used. Testing revealed that increasing the number of parameters does not improve the SNR. However, large values of l increase the complexity due to the inversion of the large matrix in Eq. (27). Finally, N needs to be known for the estimation of the autocorrelation of the observation, p_{y,m}. The observation or the observed data are traces, therefore, N is equal to the number of samples in each trace. For long recordings, the data can be divided into windows instead of processing the whole data altogether and then method of the present disclosure can be applied to these windows. The test revealed that the best values of the constants used for noise estimation are η=0.85, γ=0.998, β=0.85, αₚ=0.2, α_{d}=0.95, N̅=N/10, and h=N/20.

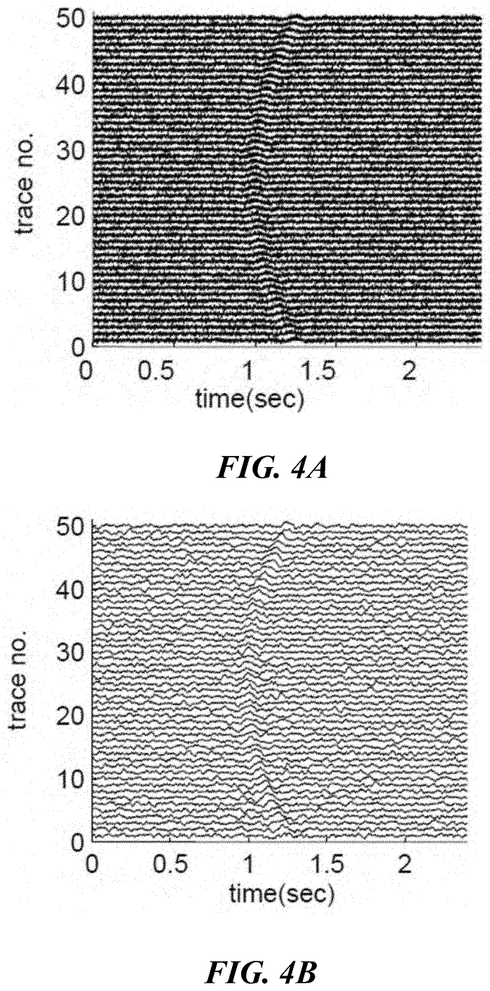

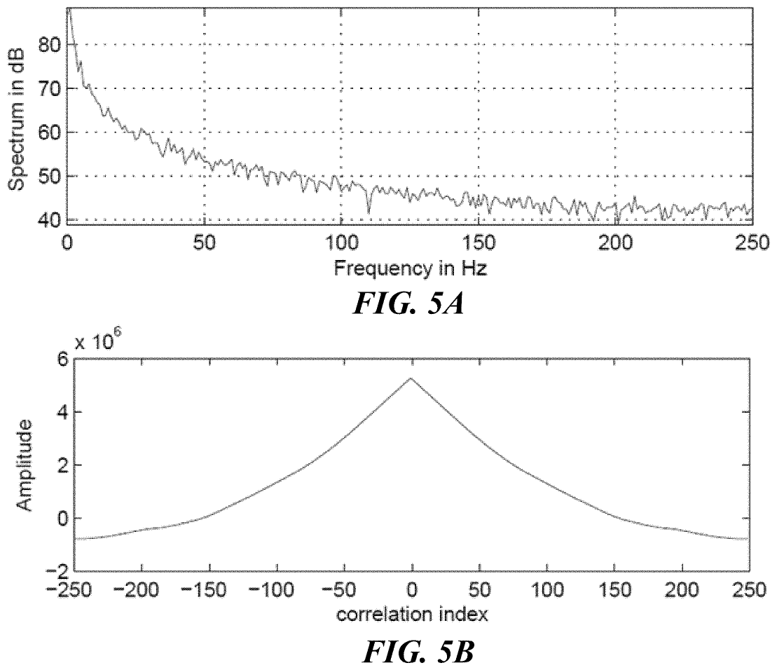

The two kinds of noise (correlated and uncorrelated noise) are added to the raw traces of FIG. 3. The SNR (defined as 10 log₁₀{σₛ²/σ_{w}²} in decibels (dB)) of the noisy observation in both cases is equal to −12 dB. It is apparent that the traces are noisy and the microseismic event is difficult to identify, as can be seen in FIGS. 4A and 4B. To generate the correlated noise, white Gaussian noise is filtered using a geophone's impulse response as shown by Hons and Stewart. (See Hons, M. S. and Stewart, R. R. (2006). “Transfer functions of geophones and accelerometers and their effects on frequency content and wavelets”. CREWES Research Report, 18, incorporated herein by reference in its entirety). After filtering, the spectrum and autocorrelation of noise are shown in FIGS. 5A and 5B, respectively. The spectrum is not flat and the autocorrelation is not an impulse, unlike white noise (uncorrelated), which has a flat spectrum and its autocorrelation is that of an impulse-type function at zero time lag (zero correlation index). The spectrum in FIG. 5A is flat but for frequencies greater than 150 Hz.

Noise is estimated first. For trace 1, the power spectrum of the noise-less data and event-presence probability Ii (with white Gaussian noise) calculated using Eq. (38), is shown in FIGS. 6A and 6B. Note that by defining a higher value of the threshold, the event can be detected with higher confidence. As seen in FIG. 6B where some noise-only regions are detected as the events. This overestimation of event is not likely to affect the enhanced event (after denoising), since the detection probability improves with the iteration and hence, eliminating the false event detected regions (FIGS. 6B-6E). The threshold value used is

$$δ = \{ \begin{matrix}2 , 1 \leq λ \leq F \\ 5 , F \leq λ \leq {f}_{\#} \text{/} 2\end{matrix} , \qquad ( 43 )$$

where F is the frequency bin corresponding to 100 Hz frequency. Above 100 Hz, a higher value of the threshold is used due to the fact that the event will be in the low frequency range (within 100 Hz).

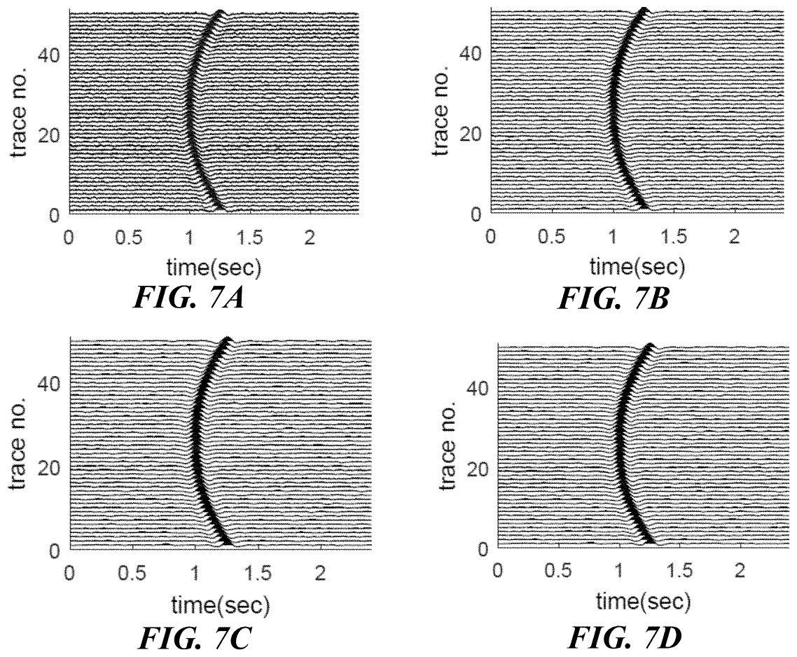

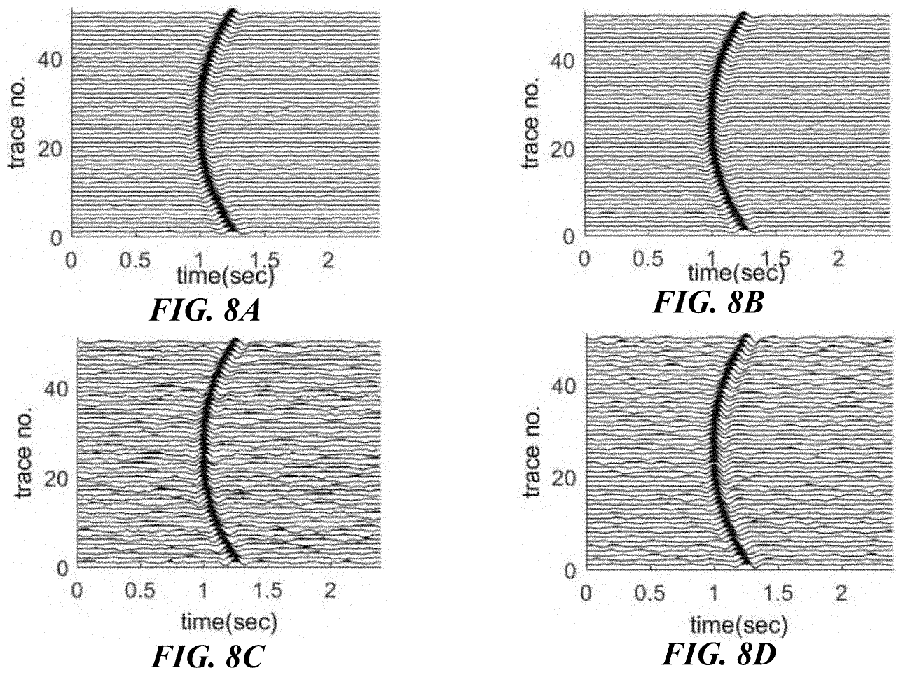

In the first experiment with white Gaussian noise (uncorrelated case), when the filter is applied to the data, the noise is increasingly suppressed with each iteration (FIG. 7A-D) and the microseismic event dominates, which proves the effectiveness of the IIR filter and enhanced method. FIGS. 8A and 8B show the denoising results (after iteration 4) for the white Gaussian noise experiment using the methods of the present disclosure (FIG. 8A) and for the enhanced method (FIG. 8B), respectively. In the second experiment with correlated noise, again the filter attenuates the noise, and the event becomes clearer (FIGS. 8C and 8D after iteration 4).

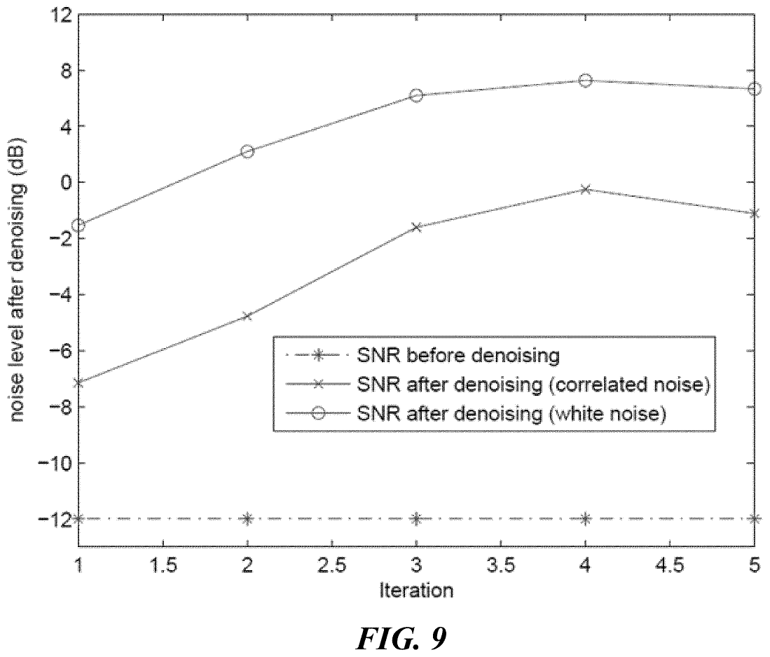

To show the improvement in SNR in each iteration, the noise level is plotted against the number of iterations, as depicted in FIG. 9. It is apparent from the figure that the SNR improves with every iteration. With more iterations, the basic assumption that noise and signal are uncorrelated is lost and, hence, the SNR starts to decrease after the fourth iteration. Consequently, only four iterations are throughout the simulation results. In order to ensure that the best results are found in terms of denoising, after the fourth iteration of applying the filter, the wavelet-based denoising can also be applied before the final output (results shown in FIGS. 7 and 8 are without the wavelet based denoising method). This is necessary to remove any in-band noise present after the filter application. The details of the wavelet denoising method are presented later.

The blind estimation of the noise is clearly an advantage of the present disclosure. However, the nature of the noise is very important. With white noise, the spectrum is flat and in moving to the time-frequency domain for the noise estimation the noise contents are more or less equally distributed along the frequency. On the other hand, with colored noise the spectrum is concentrated in some frequency bands (which include the band of the events). Since the method of the present disclosure uses the same variance (level) of the noise in both cases (white and color), the in-band noise (noise in the band of event) is less in the white noise case (contents are equally distributed along the spectrum) than in the colored noise case (contents are concentrated in some bands).

Therefore, the performance of the estimation in the colored noise case is somewhat lower than in the white noise case.

A Comparison of the Denoising Methods is Presented Below.

The quantitative assessment of the method of the present disclosure can be verified by comparing the Mean Square Error (MSE), Mean Absolute Error (MAE), SNR, Peak-Signal-to-Noise Ratio (PSNR), and maximum Correlation Coefficient (CC), which are listed in Table 1. In this table, the performance of the methods of the present disclosure of a synthetic data set with white Gaussian noise is compared with bandpass filtering, wavelet decomposition, empirical mode decomposition and FIR Wiener filtering. For denoising using wavelet decomposition, ‘wden’ function in the wavelet toolbox of Matlab is used. (See Misiti, M., Misiti, Y., Oppenheim, G., and Poggi, J. (1996). Wavelet toolbox for use with MATLAB. The MathWorks, Natick, Mass., incorporated herein by reference in its entirety.) Various wavelet basis functions with their variants, i.e, Daubechies (db2, db3, db4), Coiflets (co2, co4, co5), and Symlets (sy2, sy3, sy4), are tested on the pseudo-real data set and then coif5 wavelet is selected for comparison based on its best performance over the other wavelets. (See Daubechies, I. (1992). Ten Lectures on Wavelets. Society for Industrial and Applied Mathematics; and Mallat, S. (1989). A theory for multiresolution signal decomposition: the wavelet representation. IEEE Transactions on Pattern Analysis and Machine Intelligence, 11(7):674-693, each incorporated herein by reference in its entirety). Furthermore, soft thresholding was used with the principle of Stein's Unbiased Risk. (See Stein, C. (1981). Estimation of the Mean of a Multivariate Normal Distribution. Annals of Statistics, 9(6):1135-1151, incorporated herein by reference in its entirety). Another method used for comparison is the empirical mode decomposition that derives the basis function from the observed data. (See Rilling, G., Flandrin, P., Gonalves, P., and Lilly, J. (2007). Bivariate Empirical Mode Decomposition. IEEE Signal Processing Letters, 14(12):936-939, incorporated herein by reference in its entirety). This is also a well-known method used for denoising in geophysics. There are several different methods for denoising seismic data based on empirical mode decomposition. Here, the ensemble empirical mode decomposition with adaptive thresholding method is used. One more widely used method that is used for enhancing the SNR of noisy seismic data is interferometry. (See Al-Shuhail, A., Kaka, S. I., and Jervis, M. (2013). Enhancement of Passive Microseismic Events Using Seismic Interferometry. Seismological Research Letters, 84(5):781-784, incorporated herein by reference in its entirety). Comparison of the above-mentioned methods reveals that the methods of the present disclosure improve over the other methods (see Table 1). Moreover, comparing the performance of the method of the present disclosure with the wavelet-based method, it is evident that the IIR-based filter has improved the performance by 15% at the cost of doubling the computational complexity. For the enhanced method, stacking is done (see Eq. (42)) over the adjacent three traces. In comparing the FIR Wiener filter with the IIR Wiener filter, the length of the FIR Wiener filter is taken to be equal to N/10 (for performance and complexity compromise). Due to the inversion of a large matrix, the FIR Wiener filter took 9 sec as compared to 4 sec by the IIR Wiener filter as shown in Table 1. For a fair comparison, in this table the wavelet-based denoising is not applied after the fourth iteration for the IIR Wiener filter.

TABLE 1

| | | | SNR | PSNR | | Elapsed |
|---|---|---|---|---|---|---|
| Method | MSE | MAE | (dB) | (dB) | CC | Time (s) |
| Noisy data set | 0.39 | 0.50 | −12.03 | 4.00 | 0.244 | . . . |
| Interferometry | 0.013 | 0.085 | 2.836 | 18.868 | 0.805 | 13.18 |
| Bandpass filtering | 0.027 | 0.109 | −0.286 | 15.746 | 0.555 | 1.32 |
| Wavelet decomposition | 0.013 | 0.084 | 2.875 | 18.907 | 0.797 | 1.93 |
| Emperirical mode | 0.024 | 0.122 | 0.160 | 16.192 | 0.721 | 8.47 |
| decomposition | | | | | | |
| FIR Wiener filter | 0.0256 | 0.1021 | 0.9081 | 15.9256 | 0.645 | 9.13 |
| Proposed method | 0.011 | 0.081 | 3.643 | 19.675 | 0.838 | 4.08 |
| Proposed enhanced method | 0.009 | 0.076 | 4.285 | 20.317 | 0.863 | 3.98 |

Mean Square Error (MSE), Mean Absolute Error (MAE), Signal-to-Noise Ratio (SNR), Peak-Signal-to-Noise Ratio (PSNR), and maximum Correlation Coefficient (CC) from the synthetic data experiment (white Gaussian noise case) using bandpass filtering, interferometry, wavelent decomposition, empirical mode decomposition, FIR Wiener filtering and the method of the present disclosure (Proposed Method) and the enhanced method of the present disclosure (Proposed Enhanced Method).

Next, an earthquake data set is used to validate the method. The data set is obtained from Incorporated Research Institutions for Seismology (IRIS). The event occurred on 9^{th} October, 2017 in Central Alaska, USA and had a magnitude of Ml=5.2. The data was recorded on four tri-component (3C) sensors at a sampling frequency of 250 Hz.

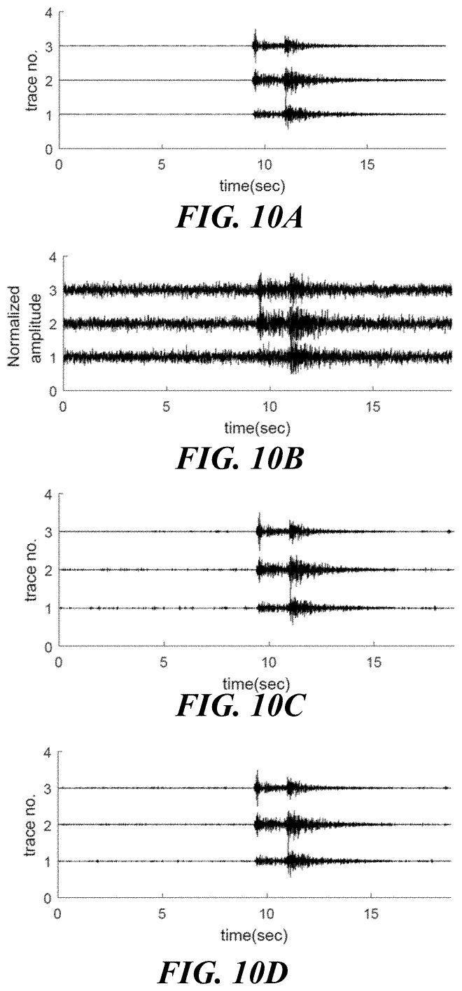

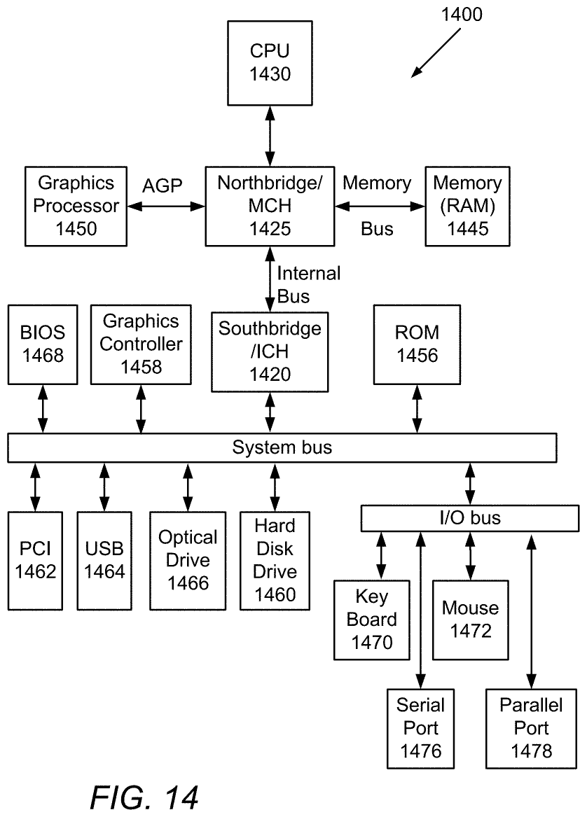

The noiseless and noisy data (corrupted with correlated noise, hereafter denominated “semi-real” or “semi-synthetic” data set) are shown in FIGS. 10A and 10B, respectively (for compactness three components are plotted on the same figure). An improvement in SNR of about 13 dB is achieved with the present method (FIG. 10C) and 14 dB improvement with the enhanced method (FIG. 10D).

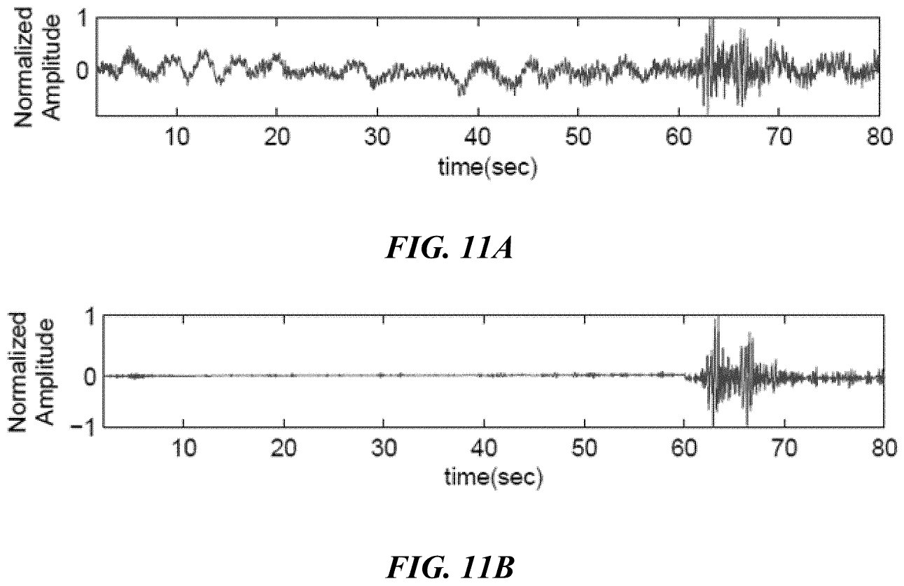

Finally, the method of the present disclosure is applied to a real data set. FIG. 11A shows the amplitude normalized and mean subtracted version of the data set. This data set is obtained from the IRIS website and the sampling rate is 4 ms. This microearthquake data set has a magnitude Ml=0.4 and a depth of 4.8 km with the seismometer located on the surface. The earthquake occurred in the California-Nevada Border Region. This scenario is taken to prove the effectiveness of the method of the present disclosure in the case of microearthquakes. The parameters used here are the same as those used for the synthetic data set.

The result of the filtering process is shown in FIG. 11B. The results are shown after the fourth iteration and application of the wavelet-based denoising approach. As demonstrated in this figure, the method of the present disclosure is able to detect the earthquake signal effectively and attenuate the noise.

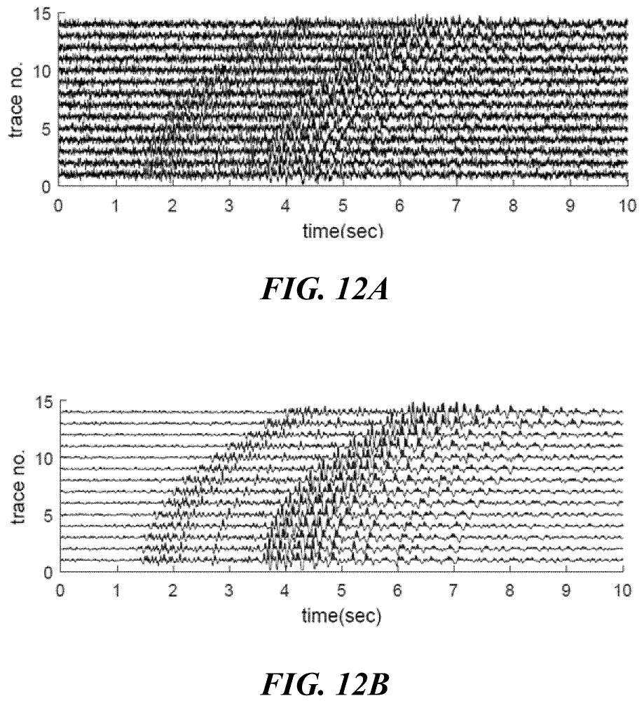

The aforementioned test was on a natural micro-earthquake. In order to demonstrate the effectiveness of the denoising method, a field data set that is used from Liu et al. (See Liu, E., Zhu, L., Govinda Raj, A., McClellan, J. H., Al-Shuhail, A., Kaka, S. I., and Iqbal, N. (2017). “Microseismic events enhancement and detection in sensor arrays using autocorrelation-based filtering”. Geophysical Prospecting, incorporated herein by reference in its entirety). This data comes from the High Resolution Seismic Network (HRSN) operated by Berkeley Seismological Laboratory, University of California, Berkeley. The sampling frequency is 250 Hz. The effectiveness of the method of the present disclosure can be seen in FIG. 12B which shows the P- and S-arrivals clearly.

Typical microseismic data are characterized by low SNR and highly non-stationary noise. Suppressing noise drastically improves signal detection, seismogram composition studies, source discrimination for small local/regional seismic sources as well as fracture characterization and monitoring in oil and gas reservoir. The SNR enhancing methods usually rely on cross-correlation from the seismic traces recorded by geophone arrays. In the present disclosure, a data-driven method to denoise seismic data is presented. In order to isolate the noise from the signal, knowledge of the second order statistics of the noise and the noisy signal must be acquired. Since the occurrence of microseismic events is sporadic, the statistics are estimated directly from the received data. Noise is first estimated and then removed from the receiver record. This makes a practical sense for microseismic denoising, since it is usually possible to estimate the statistics of the noise but not for the signal. The autocorrelations needed for the filter are either estimated from each trace separately or from multiple traces. In the former case, the advantage is that the filter can be used for a single sensor, e.g., microseismic recorded by a single station or use parallel processing as in the case of a sensor array. However, in the latter case, the correlation estimation is improved by stacking the correlation estimates obtained from multiple seismic traces recorded by a geophone array. The stacking does not involve alignment of traces, since the present method relies on the autocorrelation. Hence, ambiguities resulting from misalignment are also eliminated here. Another advantage of the method of the present disclosure is that there are no assumptions imposed on the noise statistics, which makes it suitable for applications with different noise types. Similar denoised results are obtained for the correlated and uncorrelated noise. The focus in the experimental testing is on low SNR seismic signals in order to prove the effectiveness of the method of the present disclosure. However, it is expected to perform well in case of earthquakes with magnitude greater than 2 and active (controlled source) seismic data. No underlying assumptions about the type of data are used while designing the filter.

The IIR Wiener filter based denoising method is directly based on the second-order statistics of the noise and the observations, which can be obtained easily from the recorded time-series data. The denoising method gives a promising performance in a low SNR situation. The filter does not assume any specific noise statistics; this is desirable for applicability of the denoising method to field data recorded in diverse seismic noise environments. More importantly, its computational complexity is much lower in comparison to an equivalent FIR filter approach.

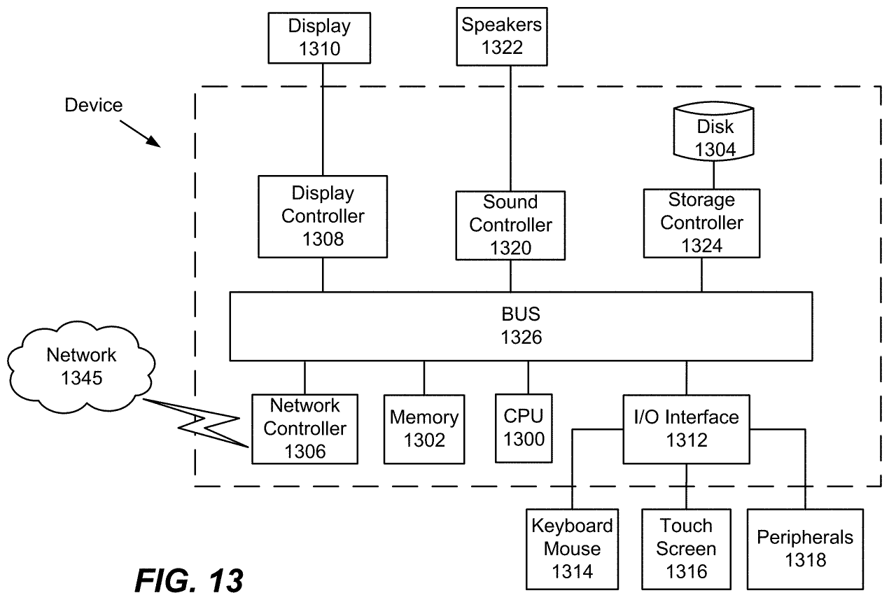

Next, a hardware description of the controller 105 according to exemplary embodiments is described with reference to FIG. 13. In FIG. 13, the controller described is representative of the controller 105 of FIG. 1A, in which the controller is a computing device which includes a CPU 1300 which performs the processes described above/below. The process data and instructions may be stored in memory 1302. These processes and instructions may also be stored on a storage medium disk 1304 such as a hard drive (HDD) or portable storage medium or may be stored remotely.

Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claimed advancements may be provided as a utility application, background daemon, or component of an operating system, or combination thereof, executing in conjunction with CPU 1300 and an operating system such as Microsoft Windows 7, UNI7, Solaris, LINUX7, Apple MAC-OS and other systems known to those skilled in the art.

The hardware elements in order to achieve the computing device may be realized by various circuitry elements, known to those skilled in the art. For example, CPU 1300 may be a Xenon or Core processor from Intel of America or an Opteron processor from AMD of America, or may be other processor types that would be recognized by one of ordinary skill in the art. Alternatively, the CPU 1300 may be implemented on an FPGA, ASIC, PLD or using discrete logic circuits, as one of ordinary skill in the art would recognize. Further, CPU 1300 may be implemented as multiple processors cooperatively working in parallel to perform the instructions of the inventive processes described above.

The computing device in FIG. 13 also includes a network controller 1306, such as an Intel Ethernet PRO network interface card from Intel Corporation of America, for interfacing with network 1345. As can be appreciated, the network 1345 can be a public network, such as the Internet, or a private network such as an LAN or WAN network, or any combination thereof and can also include PSTN or ISDN sub-networks. The network 1345 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 1308, such as a NVIDIA GeForce GT13 or Quadro graphics adaptor from NVIDIA Corporation of America for interfacing with display 1310, such as a Hewlett Packard HPL2445w LCD monitor. A general purpose I/O interface 1312 interfaces with a keyboard and/or mouse 1314 as well as a touch screen panel 1316 on or separate from display 1310. General purpose I/O interface also connects to a variety of peripherals 1318 including printers and scanners, such as an OfficeJet or DeskJet from Hewlett Packard. A sound controller 1320 is also provided in the computing device such as Sound Blaster 13-Fi Titanium from Creative, to interface with speakers/microphone 1322 thereby providing sounds and/or music.

The general purpose storage controller 1324 connects the storage medium disk 1304 with communication bus 1326, which may be an ISA, EISA, VESA, PCI, or similar, for interconnecting all of the components of the computing device. A description of the general features and functionality of the display 1310, keyboard and/or mouse 1314, as well as the display controller 1308, storage controller 1324, network controller 1306, sound controller 1320, and general purpose I/O interface 1312 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 14.

FIG. 14 shows a schematic diagram of a data processing system, according to certain embodiments, for performing the functions of the exemplary embodiments. The data processing system is an example of a computer in which code or instructions implementing the processes of the illustrative embodiments may be located.

In FIG. 14, data processing system 1400 employs a hub architecture including a north bridge and memory controller hub (NB/MCH) 1425 and a south bridge and input/output (I/O) controller hub (SB/ICH) 1420. The central processing unit (CPU) 1430 is connected to NB/MCH 1425. The NB/MCH 1425 also connects to the memory 1445 via a memory bus, and connects to the graphics processor 1450 via an accelerated graphics port (AGP). The NB/MCH 1425 also connects to the SB/ICH 1420 via an internal bus (e.g., a unified media interface or a direct media interface). The CPU Processing unit 1430 may contain one or more processors and even may be implemented using one or more heterogeneous processor systems.

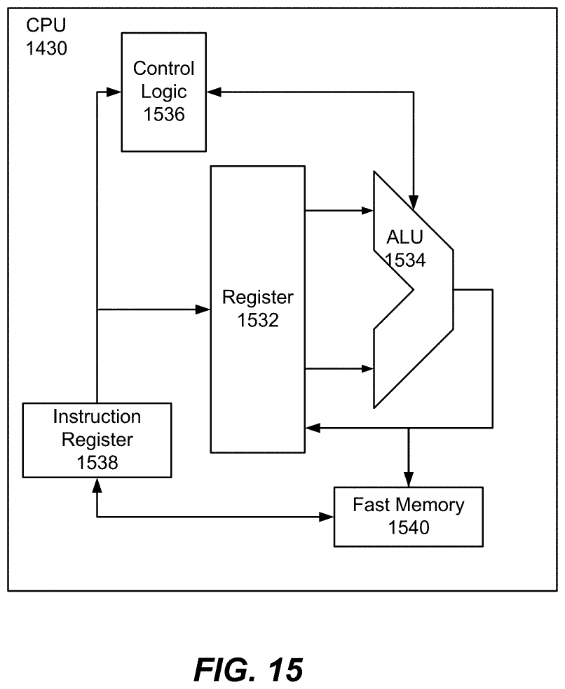

For example, FIG. 15 shows one implementation of CPU 1430. In one implementation, the instruction register 1538 retrieves instructions from the fast memory 1540. At least part of these instructions are fetched from the instruction register 1538 by the control logic 1536 and interpreted according to the instruction set architecture of the CPU 830. Part of the instructions can also be directed to the register 1532. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1534 that loads values from the register 1532 and performs logical and mathematical operations on the loaded values according to the instructions. The results from these operations can be feedback into the register and/or stored in the fast memory 1540.

According to certain implementations, the instruction set architecture of the CPU 1430 can use a reduced instruction set architecture, a complex instruction set architecture, a vector processor architecture, a very large instruction word architecture. Furthermore, the CPU 1430 can be based on the Von Neuman model or the Harvard model. The CPU 1430 can be a digital signal processor, an FPGA, an ASIC, a PLA, a PLD, or a CPLD. Further, the CPU 830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 14, the data processing system 1400 can include that the SB/ICH 1420 is coupled through a system bus to an I/O Bus, a read only memory (ROM) 1456, universal serial bus (USB) port 1464, a flash binary input/output system (BIOS) 1468, and a graphics controller 1458. PCI/PCIe devices can also be coupled to SB/ICH 1420 through a PCI bus 1462.

The PCI devices may include, for example, Ethernet adapters, add-in cards, and PC cards for notebook computers. The Hard disk drive 1460 and CD-ROM 1466 can use, for example, an integrated drive electronics (IDE) or serial advanced technology attachment (SATA) interface. In one implementation the I/O bus can include a super I/O (SIO) device.

Further, the hard disk drive (HDD) 1460 and optical drive 1466 can also be coupled to the SB/ICH 1420 through a system bus. In one implementation, a keyboard 1470, a mouse 1472, a parallel port 1478, and a serial port 1476 can be connected to the system bus through the I/O bus. Other peripherals and devices that can be connected to the SB/ICH 1420 using a mass storage controller such as SATA or PATA, an Ethernet port, an ISA bus, a LPC bridge,

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

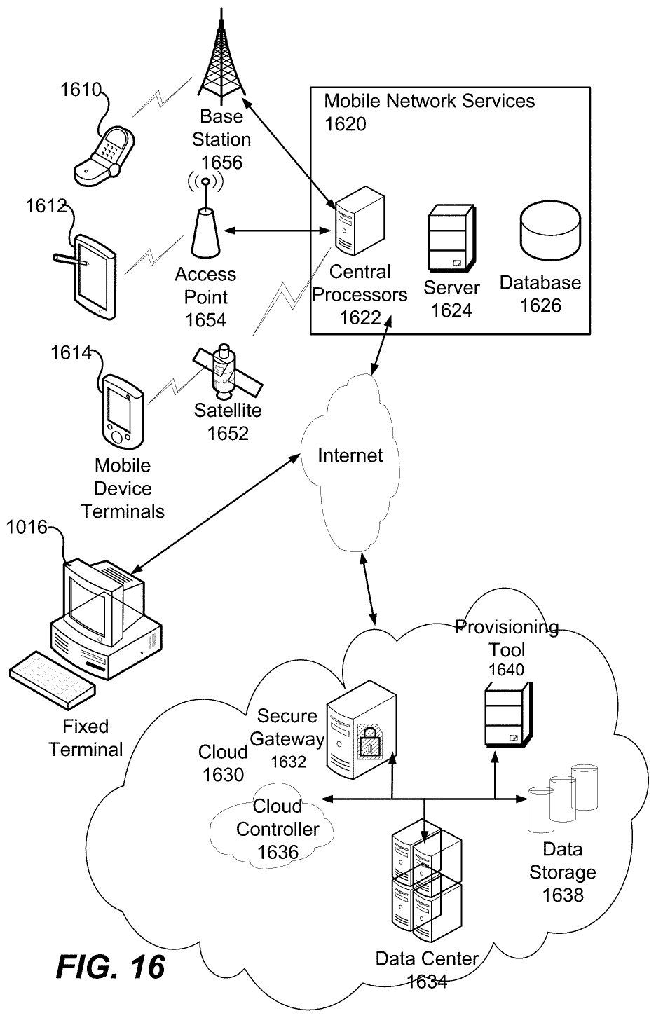

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 16, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Obviously, numerous modifications and variations of the present invention are possible in light of the above teachings. It is therefore to be understood that within the scope of the appended claims, the invention may be practiced otherwise than as specifically described herein.

1. A system for denoising microseismic data with an infinite impulse response (IIR) Weiner filter, comprising:
sensing, by M sensors placed at a geologic location, one or more microseismic events;
generating, by each one of the M sensors, one or more microseismic signals in response to the microseismic events;
transmitting, by a transmitter operatively connected to each sensor, the microseismic signals;
receiving, at a receiver, the microseismic signals;
generating, by a trace generator, a set of microseismic traces from the signals received from microseismic sensors during the sampling period (τ);
receiving, by a computing device, the set of microseismic traces;
designing, by the computing device, wherein the computing device has circuitry and program instructions configured for processing, a IIR Weiner filter for each microseismic trace, wherein designing the IIR filter includes estimating each microseismic trace as a linear transformation of the microseismic signal, and estimating coefficients of the IIR Weiner filter by minimizing a mean squared error cost function Jₖ based on the received microseismic trace; and
denoising, with the IIR Wiener filter, the microseismic trace yₖ.

2. The system for denoising microseismic data of claim 1, wherein designing a IIR Wiener filter further comprises:
modelling each trace yₖ as a time series of noise components wₖ and a time series of noisy data components sₖ;
concatenating yₖ, sₖ and wₖ into vectors;
representing the filter for each trace as a time series of components g, where g=[g₀, g₁, g₂, . . . ];
estimating the filter coefficients by minimizing a mean squared error cost function Jₖ, where Jₖ=E{s̅ₖs̅ₖ^{T}}, where sₖ is an expected error in the signal sₖ, E is the mathematical expectation and T is the transposition operator, wherein minimizing the mean square cost function includes correlating s̅ₖ and yₖ such that E{s̅ₖyₖ^{T}}=0.

3. The system for denoising microseismic data of claim 2, further comprising
autocorrelating, by the computing device, the noise components with a delayed set of noise components;
autocorrelating, by the computing device, the noisy data components with a delayed set of noisy data components;
determining autoregressive (AR) parameters for the noise and the noisy data;
using the results of the autocorrelation to improve the estimate of the IIR Weiner filter coefficients of the first denoised microseismic trace.

4. The system for denoising microseismic data of claim 3, further comprising z-transforming, by the computing device, the autoregressive noise parameters and the autoregressive noisy data parameters to generate to form a z-transform matrix C_{ww,k} representing the noise, and a z-transform matrix C_{yy,k} (representing the noisy data;
determining, by the computing device, the causal roots of C_{yy,k} (which are less than a minimum threshold defined by a unit circle in the z-plane;
forming a matrix W of the causal roots;
determining the transfer function G of the IIR Wiener filter by dividing, by the computing device, the z-transform matrix C_{ww,k} of the noise by the inverse of the matrix W multiplied by the variance squared, σ² of the microseismic trace yₖ, and subtracting the quotient from the matrix W, such that G=[(W−(C_{ww,k/}σ²W))/W];
applying the IIR Wiener filter to the noisy microseismic trace to denoise the microseismic trace and produce a denoised microseismic trace ŷₖ.

5. The system for denoising microseismic data of claim 1, further comprising
filtering the set of microseismic traces by a white noise filter, V, before designing the IIR Wiener filter for each microseismic trace;
filtering with the IIR Wiener filter, G; and
dividing out the white noise filter, V, after filtering with the IIR Wiener filter, G, to denoise the microseismic trace.

6. The system for denoising microseismic data of claim 3, further comprising stacking the autocorrelation results obtained from multiple microseismic traces for each of the noisy data and noise autocorrelations to improve the autocorrelation before determining the autoregressive (AR) parameters for the noise and the noisy data.

7. The system for denoising microseismic data of claim 1, wherein the M sensors are selected from the list comprising at least one of a geophone, a hydrophone, an acoustic sensor, a seismometer and a microphone.

8. A method for denoising microseismic data with an infinite impulse response (IIR) Weiner filter, comprising:
sensing microseismic events by M sensors placed at a geologic location;
generating microseismic signals in response to the microseismic events by each of the M sensors;
transmitting the microseismic signals to a computing device;
receiving the microseismic signals at a receiver of the computing device, the computing device having circuitry and program instructions configured for processing and analyzing signals;
generating a set of microseismic traces from signals received from microseismic sensors during a sampling period (τ) by a trace generator of the computing device;
designing a IIR Weiner filter for each microseismic trace, wherein designing the IIR filter includes estimating each microseismic trace as a linear transformation of the microseismic signal and estimating coefficients of the IIR Weiner filter by minimizing a mean squared error cost function Jₖ based on the received microseismic trace; and
denoising the microseismic trace yₖ with the IIR Wiener filter.

9. The method for denoising microseismic data of claim 8, wherein designing a IIR Wiener filter further comprises:
modelling each trace yₖ as a time series of noise components wₖ and a time series of noisy data components sₖ;
concatenating yₖ, sₖ and wₖ into vectors;
representing the filter for each trace as a time series of components g, where g=[g₀, g₁, g₂, . . . ];
estimating the filter coefficients by minimizing a mean squared error cost function Jₖ, where Jₖ=E{s̅ₖs̅ₖ^{T}}, where s̅ₖ is an expected error in the signal sₖ, E is the mathematical expectation and T is the transposition operator, wherein minimizing the mean square cost function includes correlating s̅ₖ and yₖ such that E{s̅ₖyₖ^{T}}=0.

10. The method for denoising microseismic data of claim 9, further comprising
autocorrelating the noise components with a delayed set of noise components;
autocorrelating the noisy data components with a delayed set of noisy data components;
determining autoregressive (AR) parameters for the noise and the noisy data;
using the results of the autocorrelation to improve the estimate of the IIR Weiner filter coefficients of the first denoised microseismic trace.

11. The method for denoising microseismic data of claim 10, further comprising
z-transforming the autoregressive noise parameters and the autoregressive noisy data parameters to generate to form a z-transform matrix C_{ww,k} representing the noise, and a z-transform matrix C_{yy,k} representing the noisy data;
determining the causal roots of C_{yy,k} which are less than a minimum threshold defined by a unit circle in the z-plane;
forming a matrix W of the causal roots;
determining the transfer function G of the IIR Wiener filter by dividing the z-transform matrix C_{ww,k} of the noise by the inverse of the matrix W multiplied by the variance squared, σ² of the microseismic trace yₖ, and subtracting the quotient from the matrix W, such that G=[(W−(C_{ww,k/}σ²W))/W];
applying the IIR Wiener filter to the noisy microseismic trace to denoise the microseismic trace and produce a denoised microseismic trace ŷₖ.

12. The method for denoising microseismic data of claim 8, further comprising
filtering the set of microseismic traces by a white noise filter, V, before designing the IIR Wiener filter for each microseismic trace;
filtering with the IIR Wiener filter, G; and
dividing out the white noise filter, V, after filtering with the IIR Wiener filter, G, to denoise the microseismic trace.

13. The method for denoising microseismic data of claim 10, further comprising
stacking the autocorrelation results obtained from multiple microseismic traces for each of the noisy data and noise autocorrelations to improve the autocorrelation before determining the autoregressive (AR) parameters for the noise and the noisy data.

14. A non-transitory computer readable medium having instructions stored therein that, when executed by one or more processors, causes the one or more processors to perform a method for denoising microseismic data with an infinite impulse response (IIR) Weiner filter, comprising:
sensing microseismic events by M sensors placed at a geologic location;
generating microseismic signals in response to the microseismic events by each of the M sensors;
transmitting the microseismic signals to a computing device;
receiving the microseismic signals at a receiver of the computing device, the computing device having circuitry and program instructions configured for processing and analyzing signals;
generating a set of microseismic traces from signals received from microseismic sensors during a sampling period (τ) by a trace generator of the computing device;
designing a IIR Weiner filter for each microseismic trace, wherein designing the IIR filter includes estimating each microseismic trace as a linear transformation of the microseismic signal and estimating coefficients of the IIR Weiner filter by minimizing a mean squared error cost function Jₖ based on the received microseismic trace; and
denoising the microseismic trace yₖ with the IIR Wiener filter.

15. The non-transitory computer readable medium method for denoising microseismic data of claim 14, wherein designing a IIR Wiener filter further comprises:
modelling each trace yₖ as a time series of noise components wₖ and a time series of noisy data components sₖ;
concatenating yₖ, sₖ and wₖ into vectors;
representing the filter for each trace as a time series of components g, where g=[g₀, g₁, g₂, . . . ];
estimating the filter coefficients by minimizing a mean squared error cost function Jₖ, where Jₖ=E{s̅ₖ s̅ₖ^{T}}, where s̅ₖ is an expected error in the signal sₖ, E is the mathematical expectation and T is the transposition operator, wherein minimizing the mean square cost function includes correlating s̅ₖ and yₖ such that E{s̅ₖyₖ^{T}}=0.

16. The non-transitory computer readable medium method for denoising microseismic data of claim 15, further comprising
autocorrelating the noise components with a delayed set of noise components;
autocorrelating the noisy data components with a delayed set of noisy data components;
determining autoregressive (AR) parameters for the noise and the noisy data;
using the results of the autocorrelation to improve the estimate of the IIR Weiner filter coefficients of the first denoised microseismic trace.

17. The non-transitory computer readable medium method for denoising microseismic data of claim 16, further comprising z-transforming the autoregressive noise parameters and the autoregressive noisy data parameters to generate to form a z-transform matrix C_{ww,k} representing the noise, and a z-transform matrix C_{yy,k} representing the noisy data;
determining the causal roots of C_{yy,k} which are less than a minimum threshold defined by a unit circle in the z-plane;
forming a matrix W of the causal roots;
determining the transfer function G of the IIR Wiener filter by dividing the z-transform matrix C_{ww,k} of the noise by the inverse of the matrix W multiplied by the variance squared, σ² of the microseismic trace yₖ, and subtracting the quotient from the matrix W, such that G=[(W−(C_{ww,k/}σ²W))/W];
applying the IIR Wiener filter to the noisy microseismic trace to denoise the microseismic trace and produce a denoised microseismic trace ŷₖ.

18. The non-transitory computer readable medium method for denoising microseismic data of claim 14, further comprising
filtering the set of microseismic traces by a white noise filter, V, before designing the IIR Wiener filter for each microseismic trace;
filtering with the IIR Wiener filter, G; and
dividing out the white noise filter, V, after filtering with the IIR Wiener filter, G, to denoise the microseismic trace.

19. The non-transitory computer readable medium method for denoising microseismic data of claim 16, further comprising
stacking the autocorrelation results obtained from multiple microseismic traces for each of the noisy data and noise autocorrelations to improve the autocorrelation before determining the autoregressive (AR) parameters for the noise and the noisy data.
